(19) United States
(12) Patent Application Publication
(10) Pub. No.: US 2015/0205916 A1
(43) Pub. Date: Jul. 23, 2015

(54) MEASUREMENT ASSISTANCE DEVICE, MEASUREMENT ASSISTANCE METHOD, CONTROL PROGRAM, AND RECORDING MEDIUM

(71) Applicant: Sharp Kabushiki Kaisha, Osaka-shi, Osaka (JP)

(72) Inventor: Yoshiro Yamamoto, Osaka-shi (JP)

(21) Appl. No.: 14/415,783

(22) PCT Filed: Jul. 12, 2013
(86) PCT No.: PCT/JP2013/069100

§ 371 Date: Jan. 20, 2015

(30) Foreign Application Priority Data
Jul. 26, 2012 (JP) 2012-166314

(51) Int. Cl. G06F 19/00

(52) U.S. Cl. CPC G06F 19/321; G06F 19/366; G06F 19/3487; G06T 2210/41

(57) ABSTRACT

A measurement assistance device (100) of the present invention includes an input information obtainment portion (20) that obtains input information of a measured subject that is input by a user, a saved information obtainment portion (21) that obtains saved information of the measured subject from a storage portion (30), a measurement scenario decision portion (22) that decides a measurement scenario that is applied to the measured subject based on the input information and the saved information, and a screen creation portion (23) that displays the decided measurement scenario, and realizes a measurement assistance device that assists a measuring person in efficiently and adequately performing measurement.

### TECHNICAL FIELD

The present invention relates to a measurement assistance device, a measurement assistance method, a control program, and a recording medium that assist an activity of a measuring person that conducts a measurement of a measured subject.

### BACKGROUND ART

In related art, a technology for assisting activities such as medical examinations and diagnoses for patients that are performed by health care workers has widely been used.

For example, PTL 1 discloses a remote measurement system that allows a nurse or the like to sample a body sound by using a stethoscope in a state where the image in which appropriate location marks are illustrated, the appropriate location marks indicating positions of the appropriate locations and a recording order on a virtual image of a patient. The remote measurement system records signals of an obtained auscultatory sound as a file and adds appropriate location identification data to the file. The appropriate location identification data are information that indicates the appropriate locations that are in advance configured on a surface of a patient.

PTL 2 discloses a data processing terminal that associates body sound data obtained from a patient with information such as sound collecting positions and registers those in a DB.

PTL 3 discloses a medical examination system that recognizes a measurement position where the stethoscope is put from an image that is captured by a digital camera and makes an image-capturing person confirm whether or not recognized measurement position information is correct. The medical examination system samples the auscultatory sound when the recognized measurement position is correct and thereby automatically obtains the measurement position information.

PTL 4 discloses a device that monitors the body sound of a patient and automatically determines a condition of the patient. Specifically, the device compares sampled body sound data with normal state data and abnormal state data that are in advance recorded and determines presence or absence of an abnormality. Further, a case where a doctor indicates an auscultation position to the patient is disclosed.

### CITATION LIST

### Patent Literature

PTL 1: Japanese Unexamined Patent Application Publication No. 2001-327488 (published on Nov. 27, 2001)

PTL 2: Japanese Unexamined Patent Application Publication No. 2005-27804 (published on Feb. 3, 2005)

PTL 3: Japanese Unexamined Patent Application Publication No. 2005-111260 (published on Apr. 28, 2005)

PTL 4: Japanese Unexamined Patent Application Publication No. 2008-113936 (published on May 22, 2008)

### SUMMARY OF INVENTION

### Technical Problem

However, following problems occur when the above technologies in related art are employed in a remote medical system in which a doctor or the like in a remote place performs a diagnosis for a patient.

In the above-described remote medical system, information that is necessary for a doctor to perform a diagnosis for a patient is obtained by measurement of the patient that is performed by a measuring person who is in a medical setting together with the patient. The measuring person may not necessarily have expertise that is equivalent to the doctor. Further, the measuring person may be the patient himself/herself.

Thus, in the remote medical system, it is desired that necessary and adequate information about measurement procedures is provided to the measuring person so that the measuring person who does not have the expertise equivalent to the doctor may perform appropriate measurement of the patient.

However, the above technologies in related art may not sufficiently provide appropriate information about measurement to be performed on the patient. This results in a problem that the measuring person may not adequately perform measurement that is needed by the doctor.

Further, if adequate information about the measurement procedures is not provided to the measuring person, it is possible that the measuring person performs measurement that would usually be unnecessary on the patient. Such a case results in problems that loss in human resources occurs because the patient experiences uncomfortableness or the measuring person needs extended time for the measurement and that unnecessary information increases and resources for information processing are inefficiently consumed.

Such problems are not limited to a case where the measurement that is performed on the measured subject is measurement of the body sound that is performed by using the stethoscope but may also occur in various measurement actions by using different measurement tools that are performed for understanding a condition of every kind of measured subject.

The present invention has been made in consideration of the above problems, and an objective thereof is to realize a measurement assistance device, a measurement assistance method, a control program, and a recording medium that assist a measuring person who obtains information necessary for a process such as an analysis of a condition of a measured subject from the measured subject so that the measuring person may efficiently and adequately perform measurement.

### Solution to Problem

To solve the above problems, a measurement assistance device according to the present invention is a measurement assistance device that assists measurement that is performed on a measured subject, the measurement assistance device including: input information obtainment means that receives an input by the measured subject or a measuring person and obtains input information about the measured subject; saved information obtainment means that obtains saved information about the measured subject that is stored in a storage portion based on identification information of the measured subject that is contained in the input information; measurement scenario decision means that decides a measurement scenario that is applied to the measured subject from plural measurement scenarios that indicate contents of measurement that is conducted by the measuring person and are stored in the storage portion based on the input information and the saved information that are obtained for the measured subject; and information display means that displays the decided measurement scenario on a display portion, in which the measurement scenario contains at least visualization information that illustrates a measurement position of measurement to be conducted for the measured subject.

In an above configuration, the input information about the measured subject that is input by a user is obtained by the input information obtainment means. It may be said that the input information is information that is input when measurement is performed and thus has the newest information of the measured subject. Further, the saved information about the measured subject that is in advance stored in the storage portion is obtained by the saved information obtainment means. It may be said that the saved information has invariable information about the measured subject, that is, information about the past.

The measurement scenario decision means performs overall reference to the input information and the saved information without bias and may decide an optimal measurement scenario for the measured subject based on the input information and the saved information.

The input information contains present (newest) information about the measured subject, and the saved information contains past (invariable) information about the measured subject. Plural kinds of measurement scenarios are prepared in accordance with contents of the input information and the saved information and are in advance stored. Thus, the measurement scenario that is decided by the measurement scenario decision means based on the input information and the saved information contains information that advises the measuring person of the most suitable measurement action for the measured subject who is presently receiving measurement.

The measurement scenario that is decided by the measurement scenario decision means is displayed on the display portion by the information display means so that the measuring person may visually recognize the measurement scenario.

This allows the measuring person to conduct appropriate measurement for the patient by following the measurement scenario.

The measurement scenario preferably indicates at least a content of auscultation that the measuring person conducts by using a stethoscope, the visualization information preferably contains information that specifies an auscultation position, and the information display means preferably displays visualization information that is image data in which a mark that indicates the auscultation position is added to a virtual human body image on the display portion.

In the above configuration, when the measuring person conducts measurement that is performed by using the stethoscope (auscultation), the image data in which a site to put the stethoscope is illustrated by a diagram are displayed on the display portion.

This allows the measuring person to confirm the image data, put the stethoscope in the auscultation positions that are specified by the image data, and listen to body sound data from the measured subject.

As a result, even if the measuring person does not have expert knowledge, the measuring person may correctly obtain the body sound data that is needed by an expert (such as a doctor) for a diagnosis by putting the stethoscope in the specified auscultation positions.

In the measurement assistance device, the input information obtainment means preferably obtains a name of site that indicates a site in which a symptom occurs in the measured subject as the input information, and the measurement scenario decision means preferably selects a measurement scenario that contains visualization information that indicates auscultation of an organ that corresponds to the name of site.

Plural kinds of measurement scenarios are prepared for organs of a body that correspond to the sites where symptoms occur and are in advance stored. Because the positions to put the stethoscope are different in accordance with the organs where the symptoms occur (such as respiratory organs, circulatory organs, and digestive organs), particularly, the visualization information that indicates the auscultation positions are preferably prepared at least for each of the organs.

In the above configuration, the measurement scenario decision means may appropriately select the measurement scenario that has the visualization information that indicates appropriate auscultation positions in accordance with where the site where the symptoms that the measured subject complains of occur is present.

This allows the measuring person to put the stethoscope in the auscultation positions that are specified by the image data and listen to the body sound data from correct auscultation positions in accordance with the symptoms of the measured subject.

In the measurement assistance device, the measurement scenario may further include procedure information that indicates a procedure of the measurement, the input information obtainment means may further obtain a symptom that occurs in the measured subject as the input information, the saved information obtainment means may obtain a past medical history of the measured subject and a measurement date of the measurement that the measured subject receives in a previous time as the saved information, and the measurement scenario decision means may select a measurement scenario to which a procedure of auscultation of a site of occurrence of the symptoms in the previous time is added in a case where elapsed days from a previous measurement date is shorter than prescribed days and the symptom and the name of site of the measured subject correspond to the past medical history of the measured subject.

The measurement scenario includes the procedure information that indicates a procedure of the auscultation in addition to the visualization information. For example, the procedure information may contain information that indicates a process in which auscultation is newly performed in a present time in accordance with the symptoms of the measured subject (first procedure information) and information that indicates auscultation of the same site of occurrence of symptoms as the previous time prior to the process (second procedure information).

In a case where a time between the date of the previous measurement and the date of the present measurement of the measured subject is few days and the symptoms that the measured subject complains of in the present time and the site of occurrence of the symptoms correspond to the past medical history of the measured subject with respect to the content, the previous measurement may be referred to. Accordingly, in the above configuration, the measurement scenario decision means selects the measurement scenario that refers to the previous measurement for the present measurement in a case where the above-described condition is satisfied. That is, the measurement scenario decision means selects the measurement scenario that contains the second procedure information in addition to the first procedure information.

This allows the measuring person to conduct effective auscultation by utilizing the previous measurement in a case where the previous measurement of the measured subject may be referred to.

The visualization information may contain information that specifies an auscultation order, and the information display means may display image data in which symbols that indicate the auscultation orders are added to the marks on the display portion.

The measuring person watches the image data and may thereby know not only the auscultation positions but also the order in which sound is sampled in the auscultation positions. The measuring person may efficiently conduct auscultation by following the image data.

In addition, the visualization information may contain information that specifies a listening time, and the information display means may display image data in which numerals that indicate the listening times are added to the marks on the display portion.

This allows the measuring person to know the listening time of the body sound for each of the auscultation positions together with the auscultation positions and the auscultation order. That is, the measuring person may listen to the body sound for an appropriate length. This enables avoidance of inconvenience in which a doctor or the like may not perform a correct diagnosis because a recording time of the body sound data is too short and inconvenience in which hardware resources such as a communication portion and the storage portion are inefficiently consumed because the recoding time of the body sound data is redundantly long.

The measurement assistance device may further include visualization information processing means that customizes the visualization information that is contained in the measurement scenario that is decided by the measurement scenario decision means based on at least one of the input information and the saved information of the measured subject.

More specifically, the input information obtainment means may obtain a name of site that indicates a site in which a symptom occurs in the measured subject as the input information, and the visualization information processing means may set the listening time of the auscultation position that corresponds to the obtained name of site longer than other auscultation positions.

In the above configuration, the measurement scenario that matches the measured subject is selected by the measurement scenario decision means, and the measurement scenario is in addition customized by the visualization information processing means so as to match the measured subject better.

Following such a measurement scenario allows the measuring person to conduct appropriate measurement that is specialized for the measured subject and has further rich contents for the measured subject.

Although not limited to this, for example, customization that is executed by the visualization information processing means is possible such that the auscultation positions in the visualization information (image data) are finely adjusted in accordance with a height, a weight, an age, and so forth of the measured subject, the auscultation order is changed in accordance with an age, a sex, and so forth of the measured subject, and auscultation times of specific auscultation positions are extended in accordance with the site of occurrence of symptoms of the measured subject.

To solve the above problems, a measurement assistance method of the present invention is a measurement assistance method that is executed by a measurement assistance device that assists measurement that is performed on a measured subject, the measurement assistance method including: an input information obtainment step of receiving an input by the measured subject or a measuring person and obtaining input information about the measured subject; a saved information obtainment step of obtaining saved information about the measured subject that is stored in a storage portion based on identification information of the measured subject that is contained in the input information; a measurement scenario decision step of deciding a measurement scenario that is applied to the measured subject from plural measurement scenarios that indicate contents of measurement that is conducted by the measuring person and are stored in the storage portion based on the input information and the saved information that are obtained for the measured subject; and an information display step of displaying the decided measurement scenario on a display portion of the measurement assistance device, in which the measurement scenario contains at least visualization information that illustrates a measurement position of measurement to be conducted for the measured subject.

The measurement assistance device may be realized by a computer. In this case, a control program of a measurement assistance device that causes the computer to function as the means and thereby realizes the measurement assistance device with the computer and a recording medium that is readable by a computer and records the control program are included in the scope of the present invention.

### Advantageous Effects of Invention

To solve the above problems, a measurement assistance device according to the present invention is a measurement assistance device that assists measurement that is performed on a measured subject, the measurement assistance device including: input information obtainment means that receives an input by the measured subject or a measuring person and obtains input information about the measured subject; saved information obtainment means that obtains saved information about the measured subject that is stored in a storage portion based on identification information of the measured subject that is contained in the input information; measurement scenario decision means that decides a measurement scenario that is applied to the measured subject from plural measurement scenarios that indicate contents of measurement that is conducted by the measuring person and are stored in the storage portion based on the input information and the saved information that are obtained for the measured subject; and information display means that displays the decided measurement scenario on a display portion, in which the measurement scenario contains at least visualization information that illustrates a measurement position of measurement to be conducted for the measured subject.

To solve the above problems, a measurement assistance method of the present invention is a measurement assistance method that is executed by a measurement assistance device that assists measurement that is performed on a measured subject, the measurement assistance method including: an input information obtainment step of receiving an input by the measured subject or a measuring person and obtaining input information about the measured subject; a saved information obtainment step of obtaining saved information about the measured subject that is stored in a storage portion based on identification information of the measured subject that is contained in the input information; a measurement scenario decision step of deciding a measurement scenario that is applied to the measured subject from plural measurement scenarios that indicate contents of measurement that is conducted by the measuring person and are stored in the storage portion based on the input information and the saved information that are obtained for the measured subject; and an information display step of displaying the decided measurement scenario on a display portion of the measurement assistance device, in which the measurement scenario contains at least visualization information that illustrates a measurement position of measurement to be conducted for the measured subject.

Accordingly, an appropriate measurement scenario may be provided in accordance with attributes of the measured subject. This results in an effect of allowing the measuring person to perform measurement of the measured subject by following the measurement scenario and to efficiently and appropriately obtain information that a processing person (such as a doctor) needs for a process (such as a diagnosis).

### BRIEF DESCRIPTION OF DRAWINGS

FIG. 1 is a block diagram that illustrates a main configuration of a measurement assistance device in one embodiment of the present invention.

FIG. 2 is a diagram that illustrates an outline of a remote measurement system in one embodiment of the present invention.

FIG. 3 is a diagram that illustrates a data structure and a specific example of a database of patient information that is stored in a patient information storage portion.

FIG. 4 is a diagram that illustrates one specific example of an inquiry screen.

FIG. 5 is a diagram that illustrates a data structure and specific examples of a database of measurement scenarios.

FIG. 6 is a diagram that illustrates the data structure and specific examples of the database of measurement scenarios.

FIG. 7 is a diagram that illustrates the data structure and specific examples of the database of measurement scenarios.

FIG. 8 is a diagram that illustrates the data structure and specific examples of the database of measurement scenarios.

FIG. 9 is a diagram that illustrates the data structure and specific examples of the database of measurement scenarios.

FIG. 10 is a diagram that illustrates one specific example of a measurement assistance screen.

FIG. 11 is a diagram that illustrates another specific example of auscultation position visualization information (image data).

FIG. 12 is a flowchart that illustrates a flow of processing of the measurement assistance device.

FIG. 13 is a diagram that illustrates one specific example of a measurement result screen.

FIG. 14 is a diagram that illustrates one specific example of a diagnosis input screen.

FIG. 15 is a diagram that illustrates another specific example of the image data that are displayed in output areas on the measurement assistance screen.

### DESCRIPTION OF EMBODIMENTS

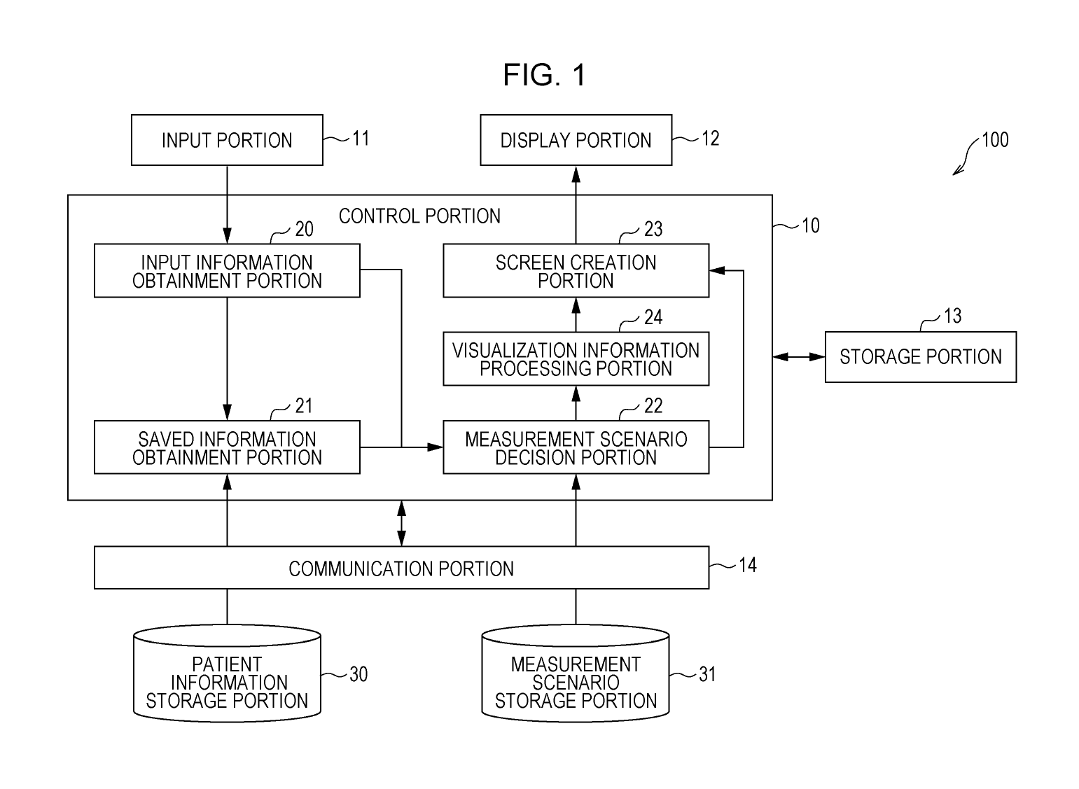

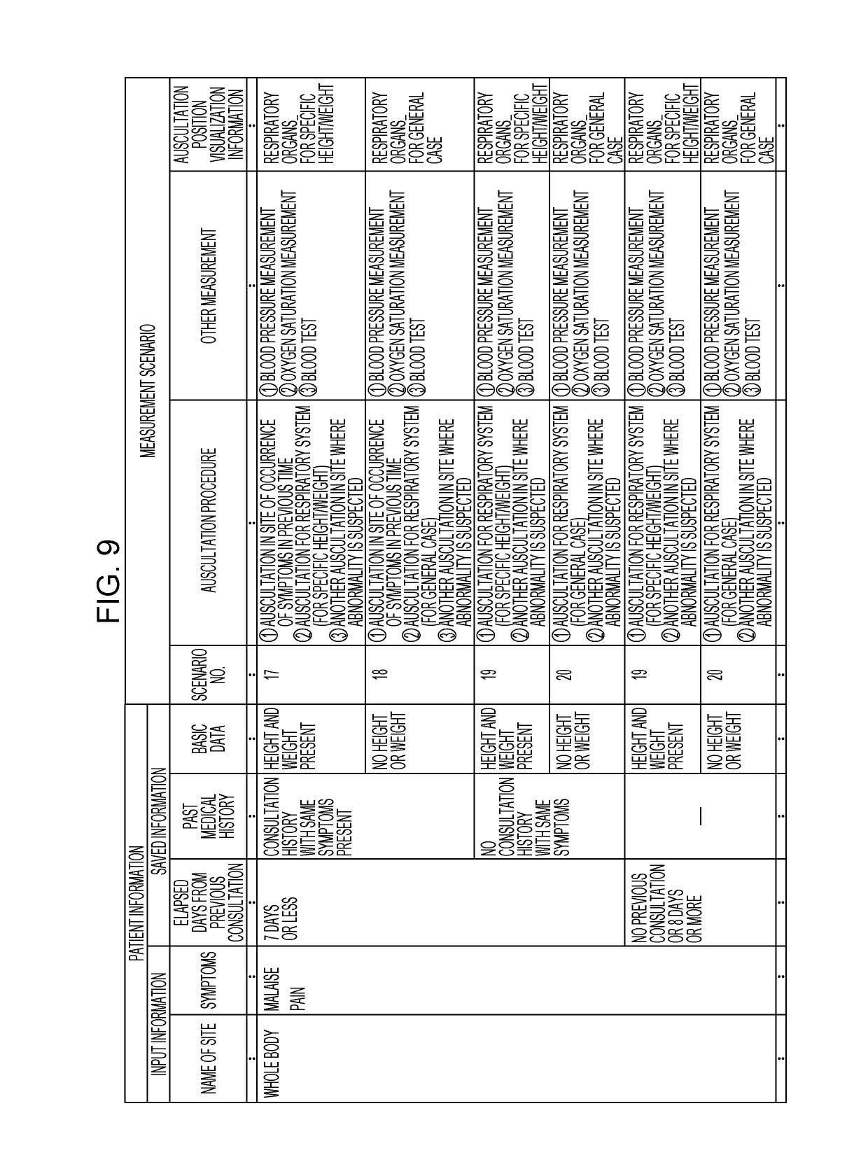

An embodiment of the present invention will hereinafter be described based on FIGS. 1 to 14.

The same reference characters are given to the same or corresponding parts in the following drawings, and descriptions thereof will not be repeated. Further, the dimension relationships among lengths, sizes, widths, and so forth and shapes in the drawings are appropriately changed for clarification and simplification of the drawings and do not represent actual dimensions or shapes.

In an embodiment that will be described below, a description will be made about a case where a measurement assistance device of the present invention is introduced to a remote measurement system as an example. Here, a remote measurement system is a system for measuring body sound of a patient (measured subject) by using an electronic stethoscope in a medical setting and for recording obtained electronic data, that is, body sound information. The remote measurement system allows a diagnosing person such as a doctor who is in a remote place from the medical setting to refer to the body sound information to use that for a diagnosis for the patient.

However, the measurement assistance device of the present invention is not limited to measurement that uses the electronic stethoscope but functions as a device that assists measurement in a case where every kind of measurement for collecting information about the patient is performed. Further, in this embodiment, the measured subject such as a patient is assumed to be a human. However, a remote measurement system that deals with every kind of body other than a human as a measured subject is included in the scope of the present invention.

Further, the measurement assistance device of the present invention is not limited to above-described examples but may be introduced to every kind of other system that obtains and uses the body sound information from the measured subject for purposes other than a diagnosis.

[Outline of Remote Measurement System]

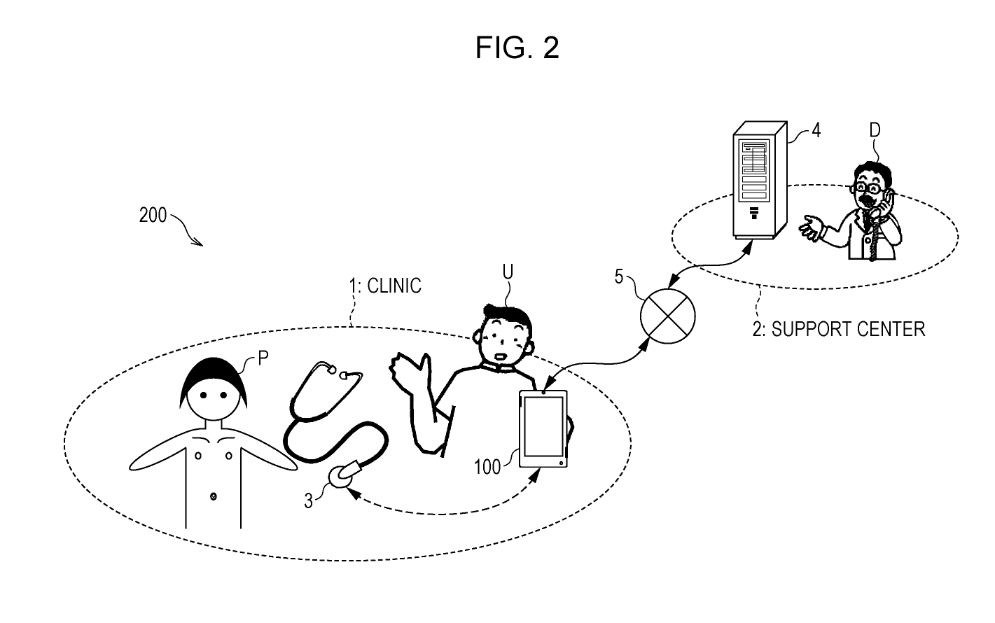

FIG. 2 is a diagram that illustrates an outline of a remote measurement system in one embodiment of the present invention. As illustrated in FIG. 2, a remote measurement system 200 is constructed to include at least a measurement tool that is used by a measuring person U for performing measurement of a patient P, that is, an electronic stethoscope 3 and a measurement assistance device 100 that assists a measurement activity (for example, auscultation or the like) that is performed by the measuring person U.

The measuring person U attends in a clinic 1 where the patient P is measured and uses various kinds of measurement tools that include the electronic stethoscope 3 to perform measurement of the patient P in the clinic 1. The various kinds of measurement tools include an oximeter, an electrocardiograph, a sphygmomanometer, a thermometer, an arteriosclerosis level evaluator, a blood vessel health evaluator, a weighing machine, and so forth other than the electronic stethoscope 3 but are not limited to those.

The measurement assistance device 100 and the electronic stethoscope 3 are by wire or wirelessly connected with each other in a communicable manner. The measuring person U may operate the measurement assistance device 100 to read out and refer to information that is necessary in measurement of the patient P. Examples of information that the measurement assistance device 100 provides to the measuring person U include patient information about the patient P (such as an electronic medical record). Further, the measurement assistance device 100 of the present invention provides a measurement scenario to the measuring person U and performs assistance for the measuring person U so that the measuring person U may adequately and efficiently conduct measurement of the patient P in the measurement of the patient P. A measurement assistance function of the measurement assistance device 100 will be described in detail below.

The measuring person U may save the body sound information that is sampled from the electronic stethoscope 3 in the measurement assistance device 100.

The measurement assistance device 100 may be realized by an information processing terminal device with high portability that is retained by the measuring person U or may be realized by a desktop personal computer (PC) or the like that is arranged in the clinic 1. In an example that is illustrated in FIG. 2, as an example, the measurement assistance device 100 of the present invention is realized by a multifunction portable communication terminal such as a tablet PC.

In a case where the measuring person U has expert knowledge, skills, and authority of a doctor, the measuring person U may measure the patient P by using the electronic stethoscope 3 and the measurement assistance device 100, give a final diagnosis of a condition of disease, and perform a treatment. As described above, a measurement system that includes the measurement tool (electronic stethoscope 3) and the measurement assistance device 100 is included in the scope of the present invention.

Alternatively, as illustrated in FIG. 2, the remote measurement system 200 may be constructed to include the electronic stethoscope 3 and the measurement assistance device 100 in the clinic 1 and a management server 4 in a support center 2 in a remote place. In this case, the measurement assistance device 100 and the management server 4 are connected with each other in a communicable manner via a communication network 5 such as the Internet.

Details will be described below. In the remote measurement system 200 of the present invention, the measuring person U may not necessarily has as high level knowledge, skills, or authority as a doctor. However, the measuring person U is capable of operating the provided measurement tool (for example, the electronic stethoscope 3) and the measurement assistance device 100 in the clinic 1. The measuring person U may be the patient P himself/herself.

The management server 4 that manages patient information of patients (electronic medical records) and measurement records that are managed in the remote measurement system 200 is provided in the support center 2 in a place that is remote from the clinic 1. That is, the body sound information that the measuring person U directly samples from the patient P by using the electronic stethoscope 3 is stored in the measurement assistance device 100 and the management server 4 via the communication network 5.

In the support center 2, a doctor D who has expert knowledge and skills reads out the patient information and the measurement records from the management server 4 by using an information processing terminal device or the like that is not illustrated and performs a diagnosis for the patient P.

As described above, in this embodiment, the measurement assistance device 100 that is realized by the tablet PC has a function of providing information related to measurement that is necessary for the measuring person U to perform measurement. Specifically, the measurement assistance device 100 reads out the patient information from the management server 4 and displays the patient information. Further, the measurement assistance device 100 selects information that is related to measurement to be conducted for the patient P based on input information such as subjective symptoms of the patient P that is input to the measurement assistance device 100 in the clinic 1 and displays the information. The measurement assistance device of the present invention that has the measurement assistance function that provides information related to measurement may be realized as the management server 4 in a remote place.

A configuration and an operation of the measurement assistance device 100 will next be described in detail.

[Configuration of Measurement Assistance Device]

FIG. 1 is a block diagram that illustrates a main configuration of the measurement assistance device 100 in one embodiment of the present invention.

As illustrated in FIG. 1, the measurement assistance device 100 is configured to include a control portion 10, an input portion 11, a display portion 12, a storage portion 13, and a communication portion 14. In a case where the measurement assistance device 100 is realized by a tablet PC, the measurement assistance device 100 may include various kinds of components that are standardly included in a tablet PC such as a sound input portion, an external interface, a sound output portion, a call processing portion, a broadcast image receiving portion (such as tuner or demodulation portion), a GPS and a sensor (such as acceleration sensor or inclination sensor), an image capturing portion, and so forth that are not illustrated.

In this embodiment, because the measurement assistance device 100 is a tablet PC, it is assumed here that the input portion 11 and the display portion 12 are integrally formed and configure a touch panel. In a case where the measurement assistance device 100 is realized by a PC or the like, the display portion 12 may be realized by a liquid crystal display monitor, and the input portion 11 may be realized by a keyboard, a mouse, and so forth.

The input portion 11 is for inputting an instruction signal by which a user operates the measurement assistance device 100 via the touch panel. The input portion 11 is configured with a touch surface that receives a contact of a pointer (such as a finger or a pen) and a touch sensor for detecting contact or non-contact (approaching or non-approaching) between the pointer and the touch surface and a contact (approaching) position thereof. The touch sensor may be realized by any sensor as long as the touch sensor is capable of detecting contact or non-contact between the pointer and the touch surface. For example, the touch sensor is realized by a pressure sensor, a capacitive sensor, a photosensor, or the like.

The display portion 12 displays the patient information (electronic medical records) that is read out by the measurement assistance device 100, displays information that assists a measurement activity of the measuring person U (the measurement scenario), and displays an operation screen by which the measuring person U operates the measurement assistance device 100 as a graphical user interface (GUI) screen. The display portion 12 is realized by a display device such as a liquid crystal display (LCD), for example.

The measurement assistance device 100 may include an operating portion that is not illustrated in order for the user to directly input the instruction signal to the measurement assistance device 100, other than the input portion 11. For example, the operating portion is realized by an appropriate input mechanism such as a button, a switch, a key, or a jog dial. The operating portion is a switch or the like that turns on or off a power source of the measurement assistance device 100.

The communication portion 14 performs communication with external devices (such as the electronic stethoscope 3 and the management server 4). In this embodiment, the communication portion 14 first includes a short-distance communication portion for short-distance communication with the electronic stethoscope 3. The short-distance communication portion performs wireless communication with the electronic stethoscope 3 and receives the body sound information that is the body sound sampled by the electronic stethoscope 3 and digitized into a digital signal. Although not particularly limited, the short-distance communication portion may realize any of wireless communication means of infrared communication such as IrDA or IrSS, Bluetooth® communication, WiFi® communication, ZigBee® communication, and a contactless IC card or may realize plural means of those.

The communication portion 14 includes a remote communication function of performing data communication with a device (such as the management server 4) in a remote place via the communication network 5 (such as local area network (LAN) or wide area network (WAN)). The communication portion 14 is used to communicate with the management server 4 when the measurement assistance device 100 reads out the patient information from the management server 4, for example. Further, the communication portion 14 is used to communicate with the management server 4 when the measurement assistance device 100 uploads the body sound information received from the electronic stethoscope 3 to the management server 4.

In a case where the measurement assistance device 100 has a cellular phone function such as a smart phone, the communication portion 14 may have a function of transmitting and receiving voice call data, electronic mail data, and so forth to and from another device via a cellular phone network.

The storage portion 13 stores (1) a control program that is executed by the control portion 10 of the measurement assistance device 100, (2) an OS program that is executed by the control portion 10, (3) application programs by which the control portion 10 executes various functions provided to the measurement assistance device 100, and (4) various kinds of data that are read out when the application programs are executed. Alternatively, the storage portion 13 stores (5) data that are used for computation in a process in which the control portion 10 executes various kinds of functions and computation results or the like. For example, data of above (1) to (4) are stored in a non-volatile storage device such as a read only memory (ROM), a flash memory, an erasable programmable ROM (EPROM), an electrically EPROM (EEPROM®), or a hard disc drive (HDD). For example, data of above (5) is stored in a volatile storage device such as a random access memory (RAM). Which data are stored in which storage devices is appropriately decided based on a purpose of use of the measurement assistance device 100, convenience, cost, physical limitations, and so forth.

The control portion 10 performs integrated control of portions that are included in the measurement assistance device 100. The control portion 10 is realized by a central processing unit (CPU), for example. The CPU as the control portion 10 reads out the programs stored in the ROM or the like to the RAM or the like and executes the programs, and the functions included in the measurement assistance device 100 are thereby realized. The various kinds of functions that are realized by the control portion 10 (particularly, the measurement assistance function) will be described below in detail with reference to another drawing.

[Function Configuration of Measurement Assistance Device]

As illustrated in FIG. 1, the control portion 10 of the measurement assistance device 100 is configured to include an input information obtainment portion 20, a saved information obtainment portion 21, a measurement scenario decision portion 22, a screen creation portion 23, and preferably a visualization information processing portion 24 as function blocks.

The input information obtainment portion 20 obtains information that is input via the input portion 11. Specifically, in this embodiment, an inquiry screen is created by the screen creation portion 23. The inquiry screen that is displayed on the display portion 12 is used for inputting information by the user (the measuring person U or the patient P). For example, the user operates the input portion 11 to input information about the patient P (hereinafter, patient information) from the inquiry screen. Although not limited to these, the patient information may include a patient ID (identification information), a patient name (identification information), a patient sex, a patient age, subjective symptoms (a site of onset, kinds of symptoms, and so forth) of a patient, a past medical history of a patient, information of the body of a patient (such as a height and a weight), a hospital visit history of a patient, and information of medication and vaccinations for a patient, and so forth.

When the above-described patient information is input via the inquiry screen, the input information obtainment portion 20 obtains the patient information and passes that to the measurement scenario decision portion 22.

The saved information obtainment portion 21 obtains the patient information which is saved in the patient information storage portion 30 and to which the measurement assistance device 100 may refer. Specifically, in this embodiment, the patient information storage portion 30 is retained by the management server 4. The saved information obtainment portion 21 accesses the patient information storage portion 30 of the management server 4 via the communication portion 14 and the communication network 5 and obtains the patient information of the patient P.

For example, although not limited to these, the patient information storage portion 30 (storage portion) stores a patient name, a patient sex, a patient age, a past medical history of a patient, information of the body of a patient (such as a height and a weight), and information of medication and vaccinations for a patient, and so forth that are associated with a patient ID.

When the patient ID is input on the inquiry screen, the saved information obtainment portion 21 obtains the input patient ID of the patient P from the input information obtainment portion 20. The saved information obtainment portion 21 then obtains other patient information of the patient P that is associated with the patient ID from the patient information storage portion 30.

The saved information obtainment portion 21 passes the obtained patient information to the measurement scenario decision portion 22.

In addition, the saved information obtainment portion 21 may supply the obtained patient information to the screen creation portion 23. The screen creation portion 23 may add the supplied patient information to the inquiry screen. This enables reduction of trouble for the user to input the patient information.

A data structure of the patient information that is stored in the patient information storage portion 30 and a specific example of the inquiry screen that is created by the screen creation portion 23 will be described in detail below with another drawing.

The measurement scenario decision portion 22 decides the measurement scenario based on the patient information that is obtained by the input information obtainment portion 20 (hereinafter, input information) and the patient information that is obtained by the saved information obtainment portion 21 (hereinafter, saved information). The “measurement scenario” is information that specifically indicates a content of measurement to the measuring person. The measurement scenario is a series of data that are configured to contain necessary and adequate information about measurement. The measuring person who does not have expertise equivalent to a doctor may perform appropriate measurement for the patient by following the measurement scenario. In this embodiment, a wide variety of measurement scenarios in accordance with patient information are stored in the measurement scenario storage portion 31. The measurement scenario storage portion 31 (storage portion) may be included in the storage portion 13 that is built in the measurement assistance device 100. However, in this embodiment, the management server 4 retains the measurement scenario storage portion 31 similarly to the patient information storage portion 30.

The measurement scenario decision portion 22 accesses the measurement scenario storage portion 31 of the management server 4 via the communication portion 14 and the communication network 5 and decides the measurement scenario to be provided to the measuring person U from various stored measurement scenarios. The measurement scenario decision portion 22 may decide a necessary measurement scenario based on the input information and the saved information that are supplied from the portions.

The screen creation portion 23 creates various graphical user interface (GUI) screens that are displayed on the display portion 12. In this embodiment, the screen creation portion 23 creates the above-described inquiry screen, for example. Further, the screen creation portion 23 shapes the measurement scenario that is decided by the measurement scenario decision portion 22 as a measurement assistance screen and displays that on the display portion 12.

Data structures of the measurement scenarios that are stored in the measurement scenario storage portion 31 and specific examples of the measurement assistance screen that is created by the screen creation portion 23 will be described in detail below with other drawings.

In the above configuration, an appropriate measurement scenario is decided by the measurement scenario decision portion 22 based on the input information about the patient that is input by the user and the saved information about the patient that is in advance stored in the patient information storage portion 30.

The input information contains present information about the patient (the kind of an abnormality that is presently occurring or the like), and the saved information contains past information about the patient. Thus, the measurement scenario that is decided by the measurement scenario decision portion 22 contains information that advises the measuring person of the most suitable measurement action for the patient who is presently receiving measurement.

The measurement scenario that is decided by the measurement scenario decision portion 22 is visualized as the measurement assistance screen by the screen creation portion 23 and provided to the measuring person.

This allows the measuring person to conduct appropriate measurement for the patient by following the measurement scenario.

The control portion 10 preferably includes the visualization information processing portion 24 in addition. The visualization information processing portion 24 analyzes information about the patient who is the measured subject and customizes a portion of the measurement scenario for the patient. Specifically, the visualization information processing portion 24 customizes visualization information that visualizes a measurement method in information contained in the measurement scenario. Specific examples of the visualization information will be described in detail below.

[Patient Information and Inquiry Screen]

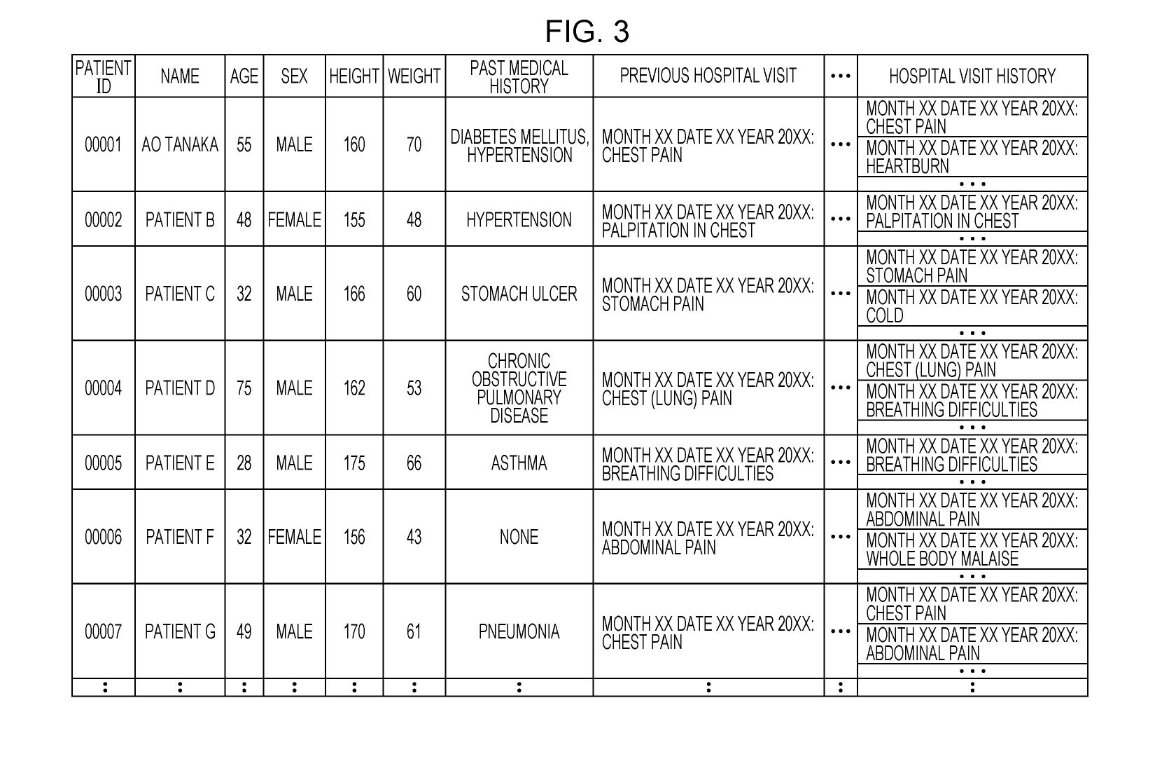

FIG. 3 is a diagram that illustrates a data structure and a specific example of a database of the patient information that is stored in the patient information storage portion 30. The patient information that is illustrated in a data structure in a table format in FIG. 3 is merely an example, and there is no intention of limiting the data structure of the patient information to a table format. This also applies to the other drawings for explaining data structures.

As described above, the patient information may contain various pieces of information related to the patient. As an example illustrated in FIG. 3, the patient information contains a name, an age, a sex, a height, a weight, a past medical history, a previous hospital visit, and a hospital visit history of the patient that are associated with the patient ID. Although not illustrated in FIG. 3, information of medication and vaccinations of the patient and so forth may also be contained as a piece of the patient information.

The newest information at a time when the patient visits the clinic 1 (such as a hospital) is stored in a column “previous hospital visit”. Pieces of information at plural past hospital visits of the patient that include the previous hospital visit are stored in a column “hospital visit history”. Those pieces of information may contain dates of hospital visits and main symptoms at those times, for example.

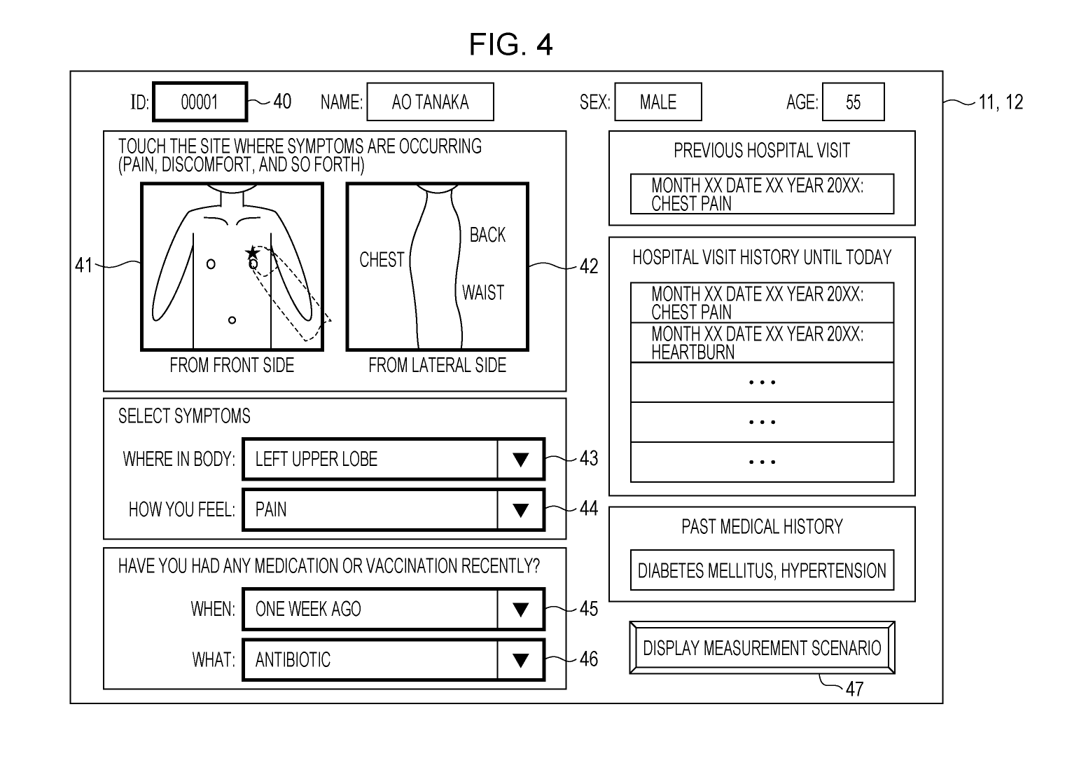

FIG. 4 is a diagram that illustrates one specific example of the inquiry screen that is created by the screen creation portion 23 and is displayed on the display portion 12.

The user of the measurement assistance device 100 (who is assumed as the measuring person U here) calls the inquiry screen to the display portion 12 in the clinic 1 before starting measurement of the patient P. The measuring person U inputs the patient ID of the patient P that the measuring person U in advance recognizes in an input area 40, for example.

The saved information obtainment portion 21 refers to the database (FIG. 3) of the patient information that is stored in the patient information storage portion 30. The saved information obtainment portion 21 then obtains the patient information about the patient P as a measurement target that is associated with the input patient ID from the database.

As illustrated in FIG. 4, the screen creation portion 23 preferably makes the inquiry screen reflect the patient information of the patient P that is obtained by the saved information obtainment portion 21. This reduces troublesome operations for inputting the patient information and enables an improvement in convenience for the measuring person U.

The measuring person U next inputs a present condition of the patient P who has some symptoms to the measurement assistance device 100.

In the example illustrated in FIG. 4, input areas 41 to 46 are further provided in the inquiry screen. The measuring person U inputs a site where abnormal symptoms that the patient P complains of occur (site of occurrence of symptoms). In this embodiment, the display portion 12 and the input portion 11 are configured with a touch panel. Thus, the measuring person U may easily input the site of occurrence of symptoms only by a touch operation on a corresponding site on a virtual human body image that is displayed in the input areas 41 and 42. Here, the measuring person U may show the input areas 41 and 42 displayed on the display portion 12 to the patient P and allow the patient P himself/herself to perform a touch operation on the site of occurrence of symptoms.

When the site of occurrence of symptoms is input in the input areas 41 and 42, a name of site that represents the site of occurrence of symptoms is displayed in the input area 43. Here, in a case where the measuring person U determines that the displayed name of site is different from the site of a complaint of the patient P, the measuring person U may operate the input area 43 to again input a correct name of site from a list of names of sites.

Specific examples of the names of sites as the input information include the right lung, the left lung, the left lower lobe, the right lower lobe, the right middle lobe, the right upper lobe, the left chest, a region around the heart, a region around the stomach, the abdomen, the lower abdomen, the whole body, the right side, the left side, and so forth other than regions illustrated in FIG. 4 but are not limited to those.

The measuring person U next operates the input area 44 to input what kinds of symptoms the symptoms that the patient P complains of are specifically. In this embodiment, a table in which the names of sites are associated with candidates of symptoms that possibly occur in the sites is stored in a table storage portion that is accessible for the measurement assistance device 100. Here, in a case where the name of site in the input area 43 is input, the screen creation portion 23 may extract candidates of symptoms that matches the name of site from the table and display a list of the candidates of symptoms in the input area 44. In a case where the candidate that matches the symptoms that the patient P complains of is contained in the list, the measuring person U selects and inputs that to the input area 44.

Specific examples of the symptoms as the input information include pain, rigor, breathing difficulties, cough, sputum, dull pain, numbness, discomfort, nausea, malaise, swelling, and so forth other than symptoms illustrated in FIG. 4 but are not limited to those.

The measuring person U may input the patient information in the input areas 45 and 46 as necessary. For example, in a case where the patient P receives medication, a vaccination, or the like, the measuring person U inputs information about a period of the reception of that to the input area 45 (for example, “one or two days ago”, “three to six days ago”, “one week ago”, “two or more weeks ago”, or the like). Further, in a case where the patient P receives a vaccination, the measuring person U inputs the kind of vaccination to the input area 46 (for example, “influenza”, “mumps”, or the like). Alternatively, in a case where the patient P receives medication, the measuring person U inputs information that indicates the name or kind of medicine to the input area 46 (for example, “digestive medicine”, “cold medicine”, “antibiotic”, or the like).

As described above, the input information obtainment portion 20 obtains the patient information related to the present condition of the patient P that is input via the inquiry screen as the input information.

Accordingly, the saved information obtainment portion 21 obtains the saved information about the patient P that is in advance saved, and the input information obtainment portion 20 obtains the input information that is newly input by the user. The patient information (the saved information and the input information) of the patient P is supplied to the measurement scenario decision portion 22. For example, a tap operation on a button 47 illustrated in FIG. 4 by the user may serve as a trigger for supply of the patient information to the measurement scenario decision portion 22. When the patient information of the patient P is received, the measurement scenario decision portion 22 reads out and decides, based on the patient information, the measurement scenario for performing appropriate measurement for the patient P from the measurement scenario storage portion 31.

[Measurement Scenario and Measurement Assistance Screen]

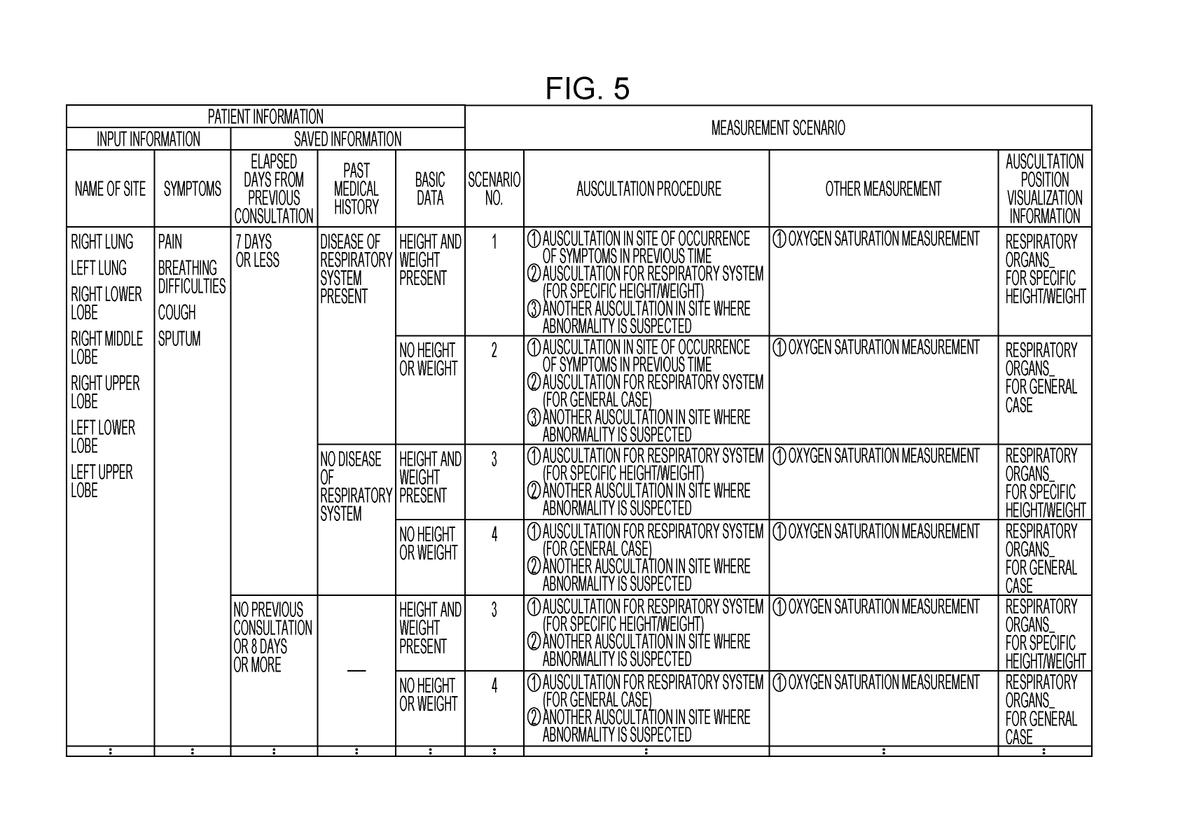

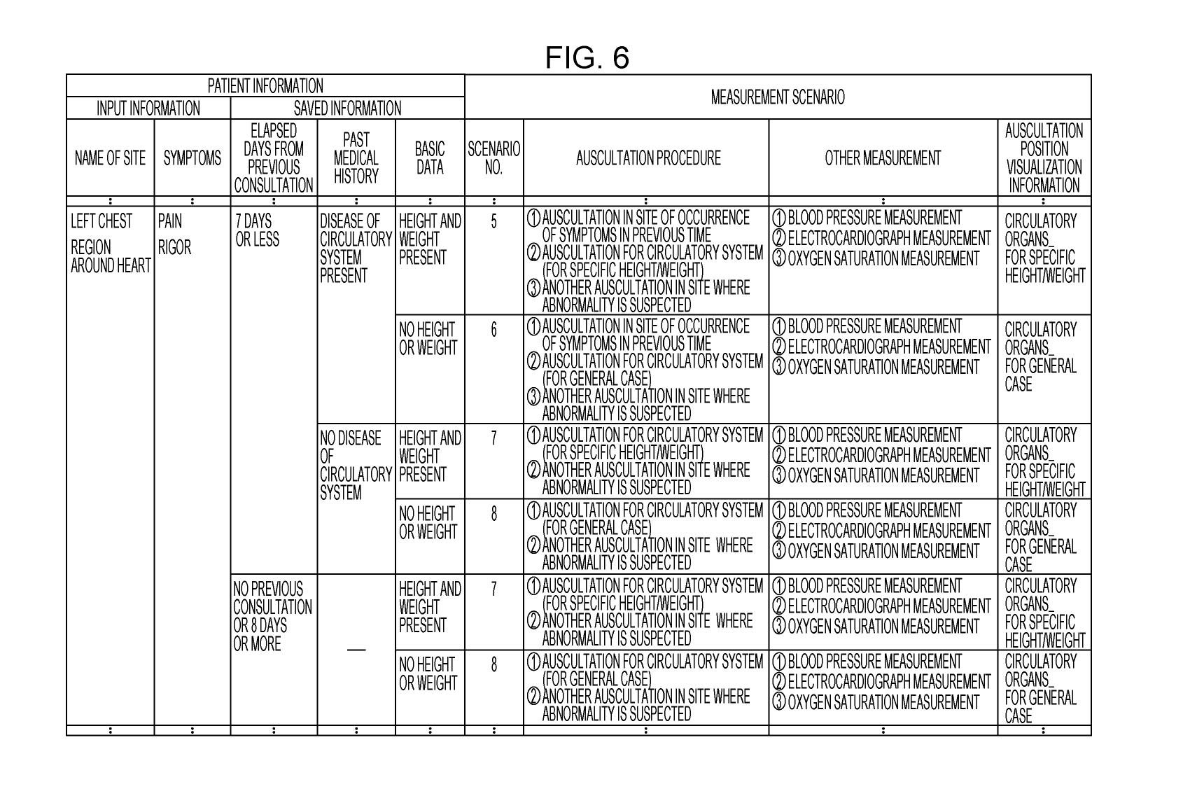

FIGS. 5 to 9 are diagrams that illustrate data structures and specific examples of the database of the measurement scenarios. As illustrated in FIGS. 5 to 9, plural measurement scenarios are defined in accordance with contents of the patient information in the database. Tables illustrated in FIGS. 5 to 9 are stored in the measurement scenario storage portion 31 as a single database. Thus, a description that will be made below with reference to FIG. 5 applies to descriptions of the database of the measurement scenarios illustrated in FIGS. 5 to 9. That is, the same description will not be repeated about FIGS. 6 to 9.

The database of the measurement scenario storage portion 31 are configured with columns that may be broadly categorized into a column of “patient information” that specifically defines a content of the patient information and a column of “measurement scenario” that defines the measurement scenario suitable for each piece of the patient information.

In this embodiment, the patient information of the patient P contains the input information that is supplied from the input information obtainment portion 20 and the saved information that is supplied from the saved information obtainment portion 21.

Thus, as illustrated in FIG. 5, the patient information is defined by the input information and the saved information. In addition, as an example, the input information has a column of the name of site and a column of the symptoms. A value that is input to the input area 43 in FIG. 4 corresponds to any of values that are stored in the column of the name of site. A value that is input to the input area 44 corresponds to any of values that are stored in the column of the symptoms.

Meanwhile, as an example, the saved information has a column of elapsed days from a previous consultation, a column of the past medical history, and a column of basic data.

The measurement scenario decision portion 22 compares a previous consultation date that is contained in the saved information “previous hospital visit” of the patient P (FIG. 3 or 4) with the date of current measurement and thereby obtains the elapsed days from the previous consultation. A value of elapsed days of the patient P that is obtained by the measurement scenario decision portion 22 corresponds to any of values that are stored in the column of the elapsed days from the previous consultation.

The measurement scenario decision portion 22 identifies diseases that the patient P has contracted in the past based on names of diseases that are contained in the saved information “past medical history” of the patient P (FIG. 3 or 4). A value of the disease of the patient P that is identified by the measurement scenario decision portion 22 corresponds to any of values that are stored in the column of the past medical history. For example, in a case where the value of “past medical history” of the patient P is “pneumonia”, the measurement scenario decision portion 22 may determine that the patient P corresponds to a value of “disease of respiratory system present” in the column of the past medical history that is illustrated in FIG. 5.

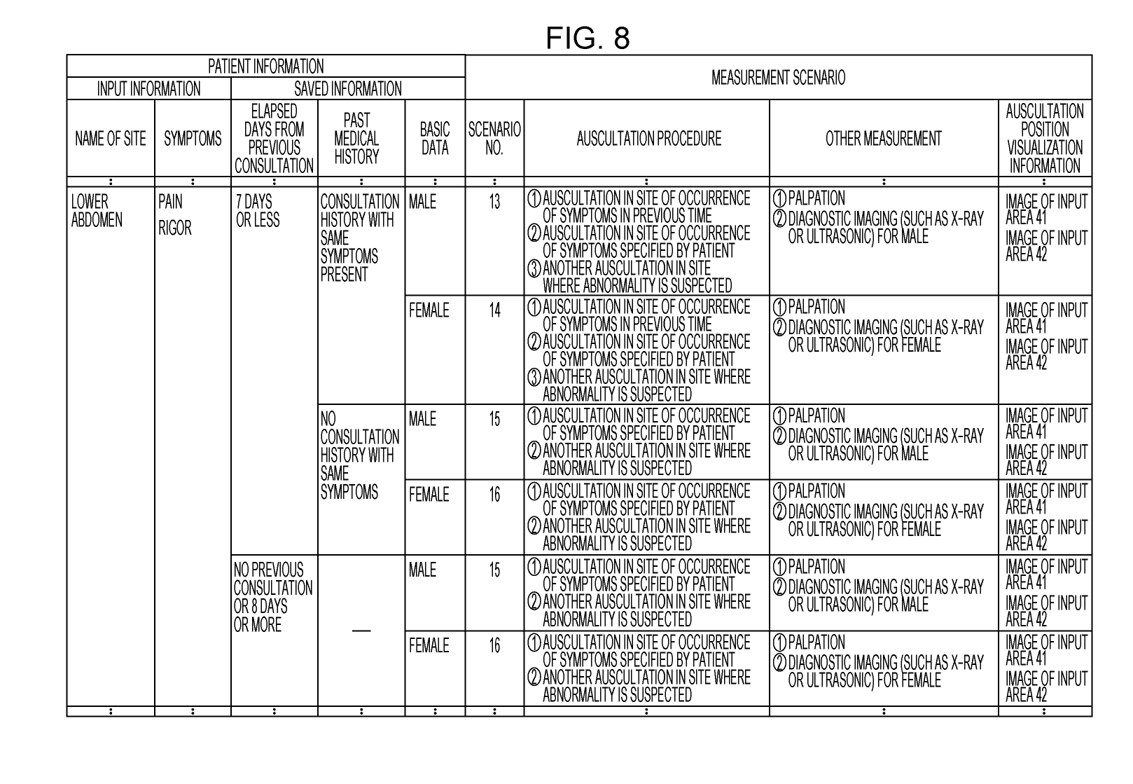

The measurement scenario decision portion 22 determines whether or not the basic data such as “age”, “sex”, “height”, or “weight” are contained in the saved information of the patient P that is supplied from the saved information obtainment portion 21 and obtains the value if the basic data is contained. A determination result or the obtained value of the measurement scenario decision portion 22 corresponds to any of values that are stored in the column of the basic data. For example, in a case where the values of “height” and “weight” of the patient P are contained in the supplied saved information, the measurement scenario decision portion 22 may determine that the patient P corresponds to a value of “height and weight present” in the column of the basic data that is illustrated in FIG. 5. Further, for example, in a case where the value of “sex” of the patient P is “male”, the measurement scenario decision portion 22 may decide that the patient P corresponds to a value of “male” in the column of the basic data that is illustrated in FIG. 8.

As described above, the measurement scenario decision portion 22 may specifically identify the content of the supplied patient information of the patient P and identify which patient information defined in the database of the measurement scenario storage portion 31 the patient P corresponds to. The measurement scenario decision portion 22 then decides the measurement scenario that is associated with the identified patient information as the measurement scenario to be used in measurement performed for the patient P.

For example, it is assumed that the measurement scenario decision portion 22 identifies the content of the patient information of the patient P as described below based on the supplied input information and saved information.

Name of site: left upper lobe
Symptoms: breathing difficulties
Elapsed days from previous consultation: 3 days (=7 days or less)
Past medical history: asthma (=disease in respiratory system present)
Height/weight: 175 cm/66 kg (=height and weight present)

In this case, the measurement scenario decision portion 22 decides the measurement scenario of scenario No. 1 that is associated with the patient information in the database of the measurement scenarios illustrated in FIG. 5 as the measurement scenario to be used.

The measurement scenario is a series of data that are configured to contain necessary information so that the measuring person who does not have expertise may perform appropriate measurement that is suitable for the patient. That is, the measurement scenario includes every kind of information that contributes to assistance for measurement activities of the measuring person.

In the example illustrated in FIG. 5, the measurement scenario has a column of scenario numbers, a column of auscultation procedures, a column of other measurement, and a column of auscultation position visualization information. The data structure of this measurement scenario is merely one example, and there is no intention of limiting the data structure of the measurement scenario in the present invention.

Identification numbers for uniquely identifying one measurement scenario are stored in the column of scenario numbers.

Information (procedure information) that indicates procedures of measurement that is performed by using the electronic stethoscope 3 (that is, auscultation) is stored in the column of auscultation procedures.

Information that indicates whether or not measurement other than auscultation that is performed by using measurement tools other than the electronic stethoscope 3 needs to be conducted is stored in the column of other measurement.

Visualization information for presenting a position of the body of the patient to be a target of auscultation to the measuring person is stored in the column of the auscultation position visualization information. The auscultation position visualization information is image data in which marks that indicate auscultation positions (measurement positions) are added to the virtual human body image, for example. The auscultation position visualization information preferably contains information that specifies an order of sampling the body sound and information that specifies plural measurement modes that are configured for electronic stethoscope 3 in addition to the auscultation positions. Specific examples of the auscultation position visualization information (image data) will be described in detail below with reference to other drawings.

When one of the measurement scenarios that contains the above pieces of information is decided by the measurement scenario decision portion 22, the screen creation portion 23 processes the decided measurement scenario to create the measurement assistance screen. The measurement assistance screen is displayed on the display portion 12 and visually recognized by the measuring person U.

As described above, the measurement scenario may specifically specify measurement sites and a measurement order for auscultation and specify necessary measurement other than auscultation and contains rich information about measurement. As a result, the measuring person who does not have expertise may appropriately and efficiently conduct measurement that is needed by a doctor by watching the measurement scenario.

It is possible that the visualization information processing portion 24 refers to the input information that is input for the patient P and the saved information that is saved for the patient P in the patient information storage portion 30 and thereby customizes the auscultation position visualization information (for example, image data) for the patient P in accordance with the contents of the input information and the saved information. Accordingly, the measuring person U refers to the customized image data and may thereby efficiently conduct measurement that is more suitable for the patient P.

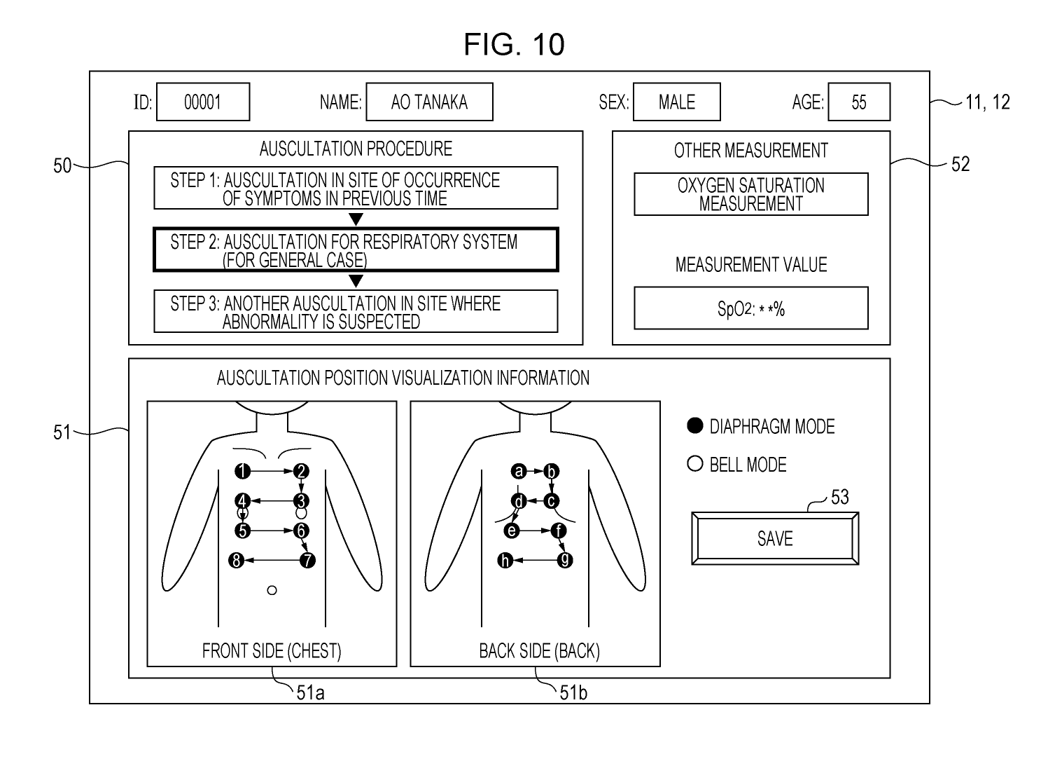

FIG. 10 is a diagram that illustrates one specific example of the measurement assistance screen that is displayed on the display portion 12. The measurement assistance screen is created by the screen creation portion 23 by following the measurement scenario that is decided by the measurement scenario decision portion 22. That is, the screen creation portion 23 visualizes each piece of information that is contained in the measurement scenario so that ingredients of the decided measurement scenario are correctly understood by the measuring person.

FIG. 10 illustrates the measurement assistance screen that reflects the content of the measurement scenario of scenario No. 2, as an example. The measurement assistance screen is configured with plural output areas that present information by which the measuring person knows a correct measurement method.

An output area 50 displays the auscultation procedure that is contained in the measurement scenario. The screen creation portion 23 preferably highlights a step of auscultation to be executed at a present point. This allows the measuring person U to easily understand the step to be executed at the present point.

An output area 52 displays information of other measurement that is contained in the measurement scenario. Specifically, the information of other measurement is information that specifies a necessary measurement item other than auscultation. The screen creation portion 23 displays another measurement item (such as oxygen saturation) in the output area 52.

An output area 51 displays auscultation area visualization information. In the example illustrated in FIG. 10, the auscultation position visualization information is image data in which the marks that indicate the auscultation positions are added to the virtual human body image. In addition, symbols such as numerals or alphabets are attached to the marks that indicate the auscultation positions. These symbols indicate an auscultation order. In addition, the marks that indicate the auscultation positions are colored. This coloring indicates a measurement mode to be configured for the electronic stethoscope 3 in auscultation.

The electronic stethoscope 3 has a function of performing measurement by plural auscultation modes such as a bell mode and a diaphragm mode. The user may switch the auscultation modes of the electronic stethoscope 3 in accordance with a purpose of measurement. The electronic stethoscope 3 may have a measurement function by an extend mode other than the above modes. The bell mode is a mode that enables listening to a low frequency domain (approximately 20 to 200 Hz) and is mainly configured in auscultation of a heart region. The diaphragm mode is a mode that enables listening to a high frequency domain (approximately 200 to 1000 Hz) and is mainly configured in auscultation of regions of respiratory organs, the heart, and digestive organs. The extend mode is a mode that enables listening to both of the ranges.

As described above, the measurement scenario contains information that specifies the auscultation modes in addition to the auscultation positions and the auscultation order in the auscultation position visualization information.

In the example illustrated in FIG. 10, the image data that are displayed in the output area 51 are the image data of “respiratory organs for general case” that are associated with scenario No. 2 (see FIG. 5). On the other hand, in a case where the image data of “respiratory organs for specific height/weight” that are associated with scenario No. 1 are displayed, the image data that correspond to the height and weight of the patient P are preferably read out and displayed. Specifically, in a case where the measurement scenario for the patient P is decided as the measurement scenario of scenario No. 1, the visualization information processing portion 24 obtains the height and weight of the patient P from the patient information storage portion 30 and reads out the image data that correspond to the height and weight of the patient P. The image data for each of heights and weights are stored in the storage portion 13 of the measurement assistance device 100 or the storage portion of the management server 4. The above configuration allows the visualization information processing portion 24 to supply the image data in which the auscultation positions are marked on the virtual human body image that corresponds to a body shape of the patient P to the screen creation portion 23 and allows the image data to be displayed in the output area 51. This allows the measuring person U to more accurately understand the auscultation positions of auscultation that is performed for the patient P by watching the image data.

The auscultation position visualization information (image data) may be prepared for each age. For example, a case is possible where the order of auscultation for a child is different from the order of auscultation for an adult. The visualization information processing portion 24 may read out the image data that corresponds to the age of the patient and supply the image data in which the auscultation order suitable for the patient is marked to the screen creation portion 23.

The screen creation portion 23 may highlight the auscultation positions to listen to at the present point so as to make those distinguishable from the other auscultation positions. For example, the screen creation portion 23 may allow the marks of the auscultation positions for which the auscultation starts from the present point to blink. As described above, it is preferable that auscultation position visualization images are not realized by a single still image but are realized by plural still images or a movie so that a display status changes in accordance with progress of auscultation. This allows the measuring person U to more accurately perform auscultation without mistaking the auscultation order.

The image data in the output area 51 that is illustrated in FIG. 10 is one example of the auscultation position visualization information that is referred to in step 2 of the auscultation procedure. The screen creation portion 23 may display the auscultation position visualization information that is referred to in step 1 in the output area 51 while step 1 is in progress. In step 1, auscultation is performed on auscultation sites where auscultation is performed in a previous consultation. The visualization information processing portion 24 may then create the image data that indicate the auscultation positions in a previous hospital visit of the patient P in accordance with the decided measurement scenario. The visualization information processing portion 24 reads out the patient information of the patient P from the patient information storage portion 30 and creates the image data that indicate the auscultation positions in previous measurement. Accordingly, the image data that indicate the auscultation positions (auscultation order and auscultation mode) in the previous measurement are displayed in the output area 51 in step 1, and the measuring person U may conduct auscultation with exactly the same procedure as a previous time. This means that the same measurement may repeatedly be executed even if a measuring person in the previous time is a different person from the measuring person U, for example. The above configuration enables an accurate comparison with a measurement result in the previous time and is thus particularly useful.

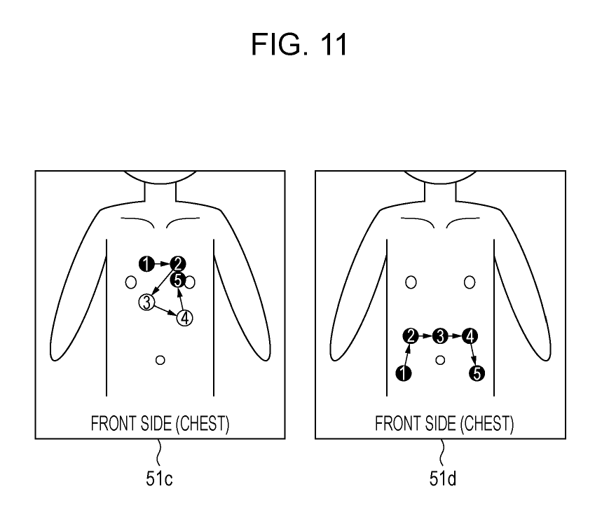

FIG. 11 is a diagram that illustrates another specific example of the auscultation position visualization information (image data) that is displayed in the output area 51.

Image data 51c are the image data for a general case that indicate the auscultation procedure for circulatory organs. For example, in a case where the measurement scenario decision portion 22 selects the measurement scenario of scenario No. 6 or No. 8 in FIG. 6, the visualization information processing portion 24 obtains the image data 51c. In this case, the screen creation portion 23 displays not image data 51a (FIG. 10) but the image data 51c in the output area 51.

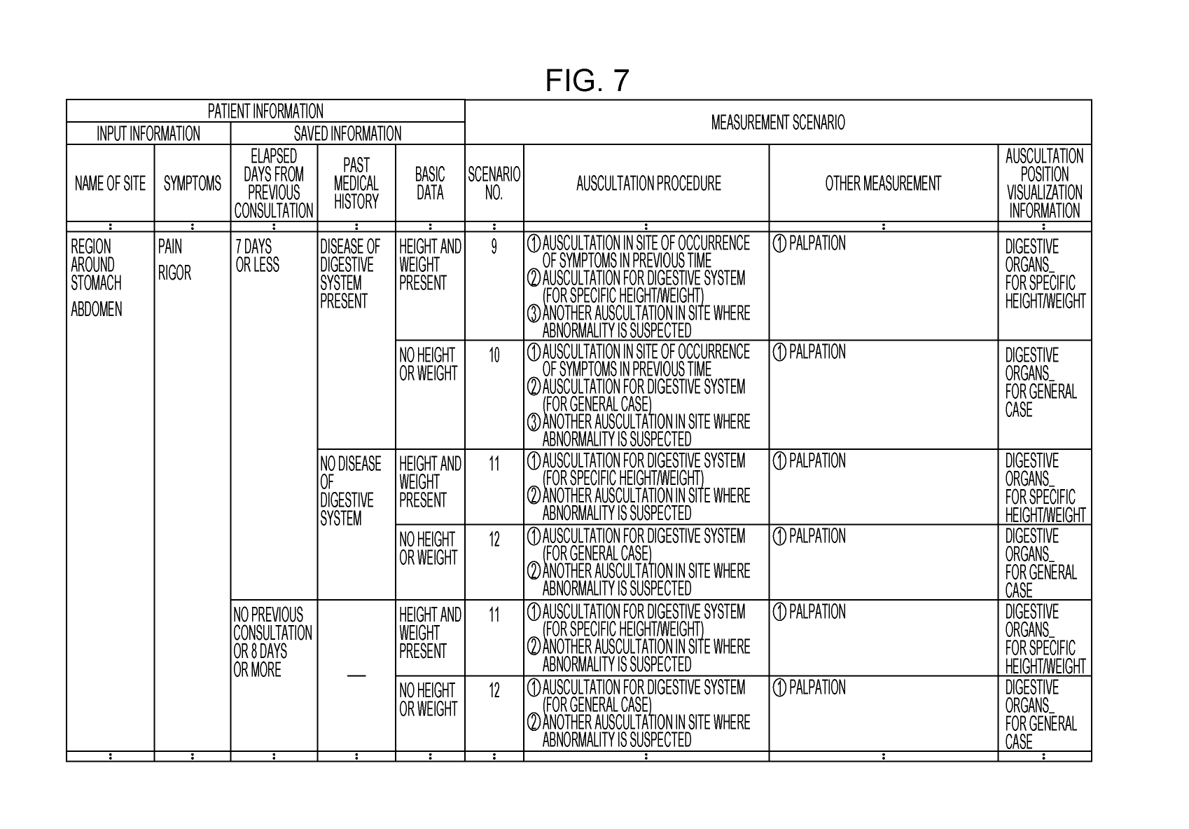

Image data 51d are the image data for a general case that indicate the auscultation procedure for the digestive organs. In a case where the measurement scenario decision portion 22 selects the measurement scenario of scenario No. 10 or No. 12 in FIG. 7, the visualization information processing portion 24 obtains the image data 51d. In this case, the screen creation portion 23 displays not image data 51a (FIG. 10) but the image data 51d in the output area 51.

[Processing Flow]

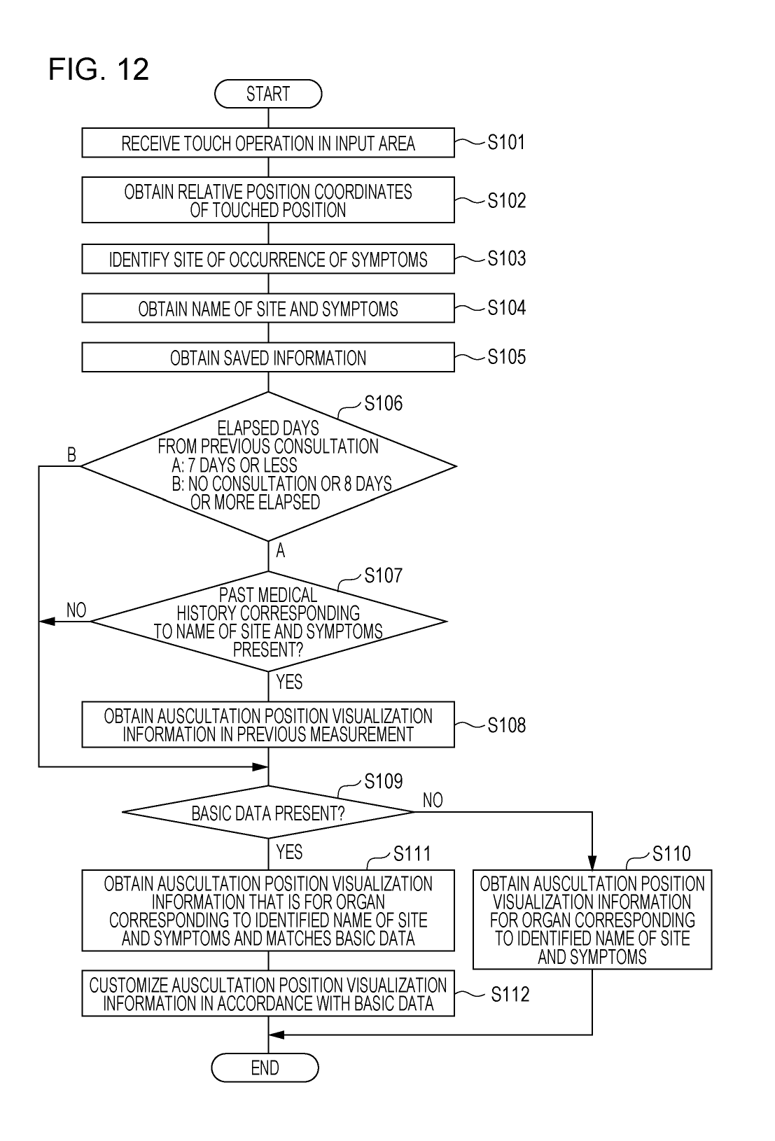

FIG. 12 is a flowchart that illustrates a flow of processing of the measurement assistance device 100.

The input portion 11 receives a touch operation of the measuring person U (S101). For example, as illustrated in FIG. 4, it is assumed that the measuring person U touches the site of occurrence of symptoms that the patient P complains of in the input area 41.

The input information obtainment portion 20 obtains relative position coordinates that indicate which position in the image data in the input area 41 is touched based on a position where the input area 41 is displayed and coordinates of a touched position on the display portion 12 (S102). This allows the input information obtainment portion 20 to identify the site of occurrence of symptoms that is input by the user (the measuring person U or the patient P) (S103). The screen creation portion 23 may attach a mark to the touched position so that the identified site of occurrence of symptoms is found (FIG. 4).

The input information obtainment portion 20 obtains the name of site and the symptoms (S104). The input information obtainment portion 20 may obtain the name of site that represents the site of occurrence of symptoms that is identified in S103 from the names of sites that are in advance defined. For example, in a case where the site of occurrence of symptoms (star mark) that is illustrated in FIG. 4 is input, the input information obtainment portion 20 may obtain the name of site “left upper lobe”. Alternatively, the input information obtainment portion 20 may obtain the name of site “left upper lobe” that is input in the input area 43. Further, the input information obtainment portion 20 obtains symptoms (for example, “pain” or the like) that are input in the input area 44.

The saved information obtainment portion 21 obtains the saved information about the patient P from the patient information storage portion 30 (S105). In this embodiment, the user inputs the patient ID that is assigned to the patient P in the input area 40. The saved information obtainment portion 21 obtains various kinds of patient information (FIG. 3) that are associated with the patient ID that is obtained by the input information obtainment portion 20.

The measurement scenario decision portion 22 next decides the measurement scenario that is suitable for the patient P from the ones that are stored in the measurement scenario storage portion 31 based on the input information about the patient P (such as the name of site and the symptoms) and the saved information (such as a height, a weight, and an age). Particularly, the measurement scenario decision portion 22 decides the auscultation position visualization information that indicates the auscultation positions (the auscultation order, the auscultation mode, and so forth) that corresponds to the patient P.

The measurement scenario decision portion 22 obtains the elapsed days from a previous measurement date to a present measurement date based on the hospital visit history of the patient P. Here, the measurement scenario decision portion 22 determines whether only seven days (or less) elapse from the previous measurement date or eight days or more elapse (S106). In a case where there is no history of the previous measurement, the elapsed days correspond to the latter. In a case where the elapsed days from the previous measurement date are seven days or less (A in S106), the measurement scenario decision portion 22 determines whether or not the past medical history of the patient P corresponds to the name of site and the symptoms that are obtained in S104 (S107). For example, in a case where the name of site is “left upper lobe” and the symptoms are “pain”, the past medical history is considered to be a disease that is associated with the respiratory system. Accordingly, in a case where the past medical history of the patient P is a disease of the respiratory system (such as pneumonia or asthma), the measurement scenario decision portion 22 determines that the past medical history that corresponds to the name of site and the symptoms is present.

In a case where the measurement scenario decision portion 22 determines that the corresponding past medical history is present (YES in S107), the measurement scenario decision portion 22 selects the measurement scenario in which auscultation is performed along the auscultation positions in the previous measurement. The visualization information processing portion 24 obtains the auscultation position visualization information in the previous measurement in accordance with the decision of the measurement scenario decision portion 22 (S108). The auscultation position visualization information in the previous measurement may be stored in the patient information storage portion 30 while being associated with the patient ID of the patient P or may be stored in a measurement result storage portion that stores the measurement result in the previous measurement and is not illustrated. Alternatively, the visualization information processing portion 24 may create the auscultation position visualization information (image data) that indicate the auscultation positions in the previous measurement based on the previous measurement result.

On the other hand, in a case where the present time is a first measurement or eight days or more elapse after the previous measurement (B in S106) or a case where there is no past medical history that corresponds to symptoms of the present time (NO in S107), the measurement scenario decision portion 22 does not refer to the auscultation positions in the previous measurement. That is, the measurement scenario decision portion 22 selects the measurement scenario that does not contain the auscultation positions in the previous measurement.

In addition, the measurement scenario decision portion 22 determines whether or not the basic data about the patient P such as the height, weight, and age of the patient P are contained in the input information that is obtained in S101 or in the saved information that is obtained in S105 (S109). In a case where the measurement scenario decision portion 22 determines that the basic data are not obtained (NO in S109), the measurement scenario decision portion 22 does not take the basic data into account. That is, the measurement scenario decision portion 22 selects the measurement scenario that contains highly versatile information that applies to general patients. Accordingly, the visualization information processing portion 24 obtains the auscultation position visualization information for a general case for auscultation of the body sound of organs that correspond to the names of sites and the symptoms that are identified in S104, from the storage portion 13 (or the storage portion of the management server 4) (S110).

On the other hand, in a case where the measurement scenario decision portion 22 determines that the basic data are obtained (YES in S109), the measurement scenario decision portion 22 takes the basic data into account. That is, the measurement scenario decision portion 22 selects the measurement scenario that contains specific information that applies to the basic data of the patient. Accordingly, the visualization information processing portion 24 obtains the auscultation position visualization information that corresponds to specific basic data from the storage portion (S111). Here, the auscultation position visualization information is also information for auscultation of the body sound of organs that correspond to the names of sites and the symptoms that are identified in S104. In addition, the visualization information processing portion 24 may customize the auscultation position visualization information based on the basic data of the patient P as necessary (S112). For example, the visualization information processing portion 24 may perform fine adjustment of the positions of the marks of the auscultation positions that are contained in the auscultation position visualization information in accordance with the height and weight or switch the auscultation orders in accordance with the age.

In S112, the visualization information processing portion 24 may add a mark that emphasizes the site of occurrence of symptoms that the patient P complains of and that is identified in S103 to the obtained auscultation position visualization information in S112. The visualization information processing portion 24 quantifies the site of occurrence of symptoms that is identified in S103 (for example, XX cm above, YY cm to the right, or the like from a reference position). The reference position represents a portion of the body that has a characteristic external appearance such as the navel, the nipple, or the clavicle. Further, a part whose position is not largely different depending on the person and that is optimal to serve as a reference is selected as the reference position.

The measurement scenario that contains the auscultation position visualization information that is obtained (created) as described above is supplied to the screen creation portion 23. The screen creation portion 23 processes the supplied measurement scenario into the measurement assistance screen and displays that on the display portion 12. Accordingly, the measurement scenario is visualized and is visually recognized by the measuring person U.

This allows the measuring person U to confirm positions to perform auscultation and understand the positional relationship between the auscultation positions and the site on which the patient P complains of the symptoms.

[Measurement Flow and Measurement Result Screen]

The measuring person U may confirm the image data and move forward the measurement as described below. For example, it is assumed that the measuring person U confirms the image data on a front side in the output area 51 in FIG. 10 and confirms that the mark of auscultation position No. 1 blinks. The measuring person U sets the electronic stethoscope 3 to the diaphragm mode by following the measurement assistance screen and starts auscultation by putting the electronic stethoscope 3 on the position that corresponds to auscultation position No. 1 on the body of the patient P. When the electronic stethoscope 3 finishes obtaining the body sound of the patient P in the position that corresponds to auscultation position No. 1, the measuring person U taps a button 53. Body sound data of the body sound is thereby transmitted from the electronic stethoscope 3 to the measurement assistance device 100. A measurement data management portion of the measurement assistance device 100 that is not illustrated stores information indicating the auscultation position (for example, “No. 1”) that is associated with the body sound data in a measurement result storage portion (not illustrated) that stores measurement results. The measurement result storage portion may be the storage portion 13 or the storage portion of the management server 4.

As described above, the measuring person U confirms the auscultation position visualization information that is displayed in the output area 51 and may thereby efficiently and properly obtain and save the information that is necessary for the diagnosis.

In addition, the screen creation portion 23 may create a measurement result screen by which the user confirms the measurement result that is stored in the measurement result storage portion and display that on the display portion 12.

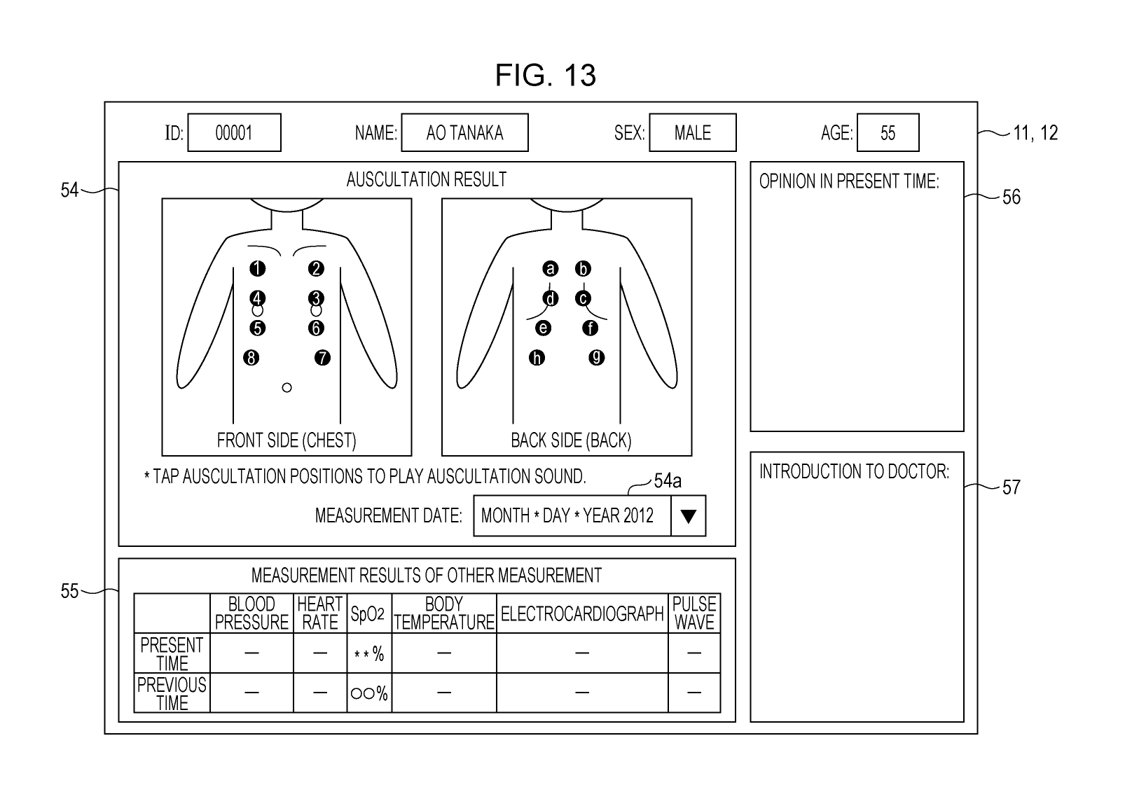

FIG. 13 is a diagram that illustrates one specific example of the measurement result screen that is displayed on the display portion 12.

The screen creation portion 23 may read out the measurement result of the patient P that is stored in the measurement result storage portion, create the measurement result screen, and display that on the display portion 12.

An output area 54 illustrated in FIG. 13 displays an auscultation result. As described above, the body sound data are stored while being associated with the auscultation position. Thus, it is preferable that the screen creation portion 23 displays the virtual human body image and the auscultation positions in the output area 54 and displays a user interface (UI) screen that is configured such that when the mark of the auscultation position is selected, the body sound data of the auscultation position may be played.

Plural times of auscultation may be conducted for a single patient on different dates. Thus, the screen creation portion 23 preferably provides an input area 54a to input a measuring date in the measurement result screen. This allows the user to call the auscultation result of the patient P on a specific measurement date to the output area 54.

In addition, in a case where measurement other than the auscultation is performed, the screen creation portion 23 may display a measurement result of the other measurement (output area 55).

In addition, the screen creation portion 23 may provide an input area 56 in which the measuring person U who performs the measurement inputs an opinion within the range of his/her understanding and an input area 57 in which the measuring person U inputs items about which he/she consults a doctor in the measurement result screen. Information that is input via the input area 56 and the input area 57 is stored in the measurement result storage portion while being associated with the patient ID of the patient P and the measurement date.

The doctor D (FIG. 2) may refer to the measurement result screen. Thus, the management server 4 that is operated by the doctor D has the screen creation portion 23. Similarly to the measurement assistance device 100, the screen creation portion 23 of the management server 4 reads out the measurement result of the patient P that is stored in the measurement result storage portion, creates the measurement result screen, and displays that on the display portion of the management server 4.

[Diagnosis Input Screen]

In the remote measurement system 200 (FIG. 2) of the present invention, the measurement assistance device 100 of the present invention is provided, and a case described below is thereby realized. That is, the doctor D who is in a remote place (the support center 2) may analyze the measurement result that is obtained by the measurement performed by the measuring person U and perform a diagnosis for the patient P by operating the management server 4. As described above, the doctor D may call the measurement result screen and perform the diagnosis by operating the management server 4 and may further input and save a diagnosis result for the measurement result. A diagnosis input screen by which the doctor D inputs the diagnosis result is created by the screen creation portion 23 of the management server 4.

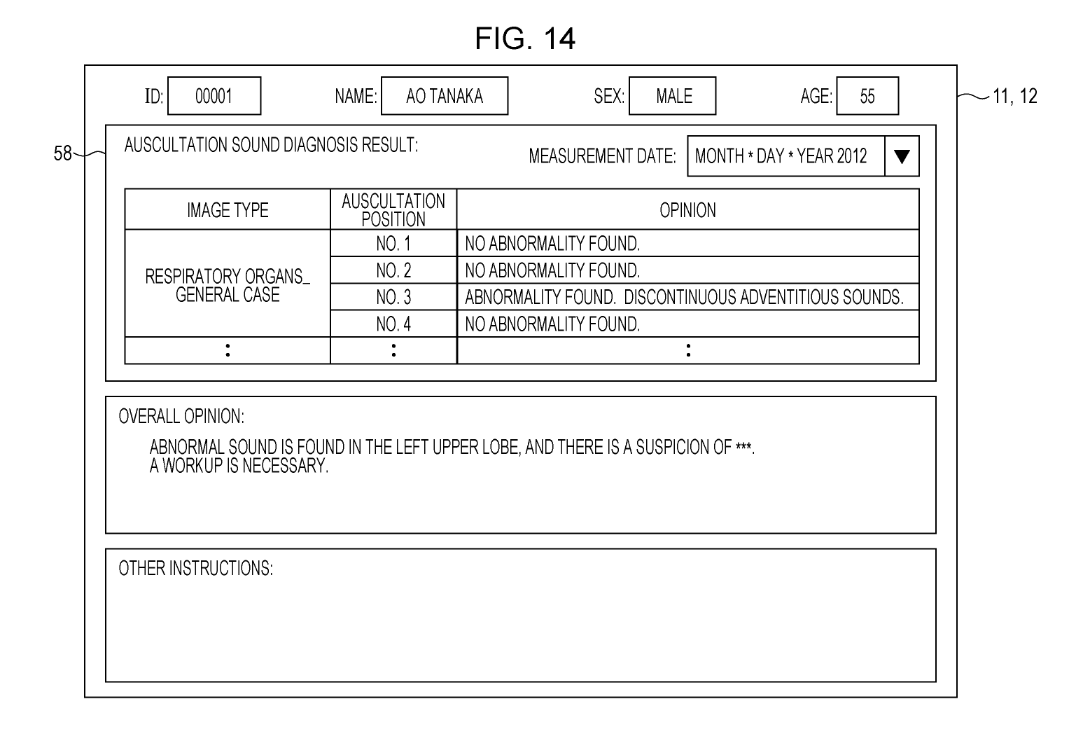

FIG. 14 is a diagram that illustrates one specific example of a diagnosis input screen that is displayed on the display portion to which the doctor refers.

The screen creation portion 23 of the management server 4 creates the diagnosis input screen that is illustrated in FIG. 14 and displays that on the display portion to which the doctor D may refer. The diagnosis input screen is created with the patient ID and the measurement date as keys, for example. That is, information that is input by the doctor D via the diagnosis input screen is stored in the measurement result storage portion with the patient ID and the measurement date as the keys.

In this embodiment, the screen creation portion 23 provides an input area 58 so that the doctor D may input an opinion for each of plural auscultation positions (body sound) in one time of measurement.

Accordingly, information of the diagnosis result by the doctor D may be stored and managed while being associated with the body sound data of each of the auscultation positions.

### Modification Examples

The measurement scenario that is stored in the measurement scenario storage portion 31, particularly, the auscultation position visualization information may contain information that specifies a time to put the electronic stethoscope 3 (listening time) in addition to the information that specifies the auscultation positions, the auscultation order, and the auscultation mode.

For example, in the auscultation position visualization information, the listening time (the number of seconds) may be notified to the measuring person U by displaying the number of seconds on the right shoulder of the mark of the auscultation position that indicates the auscultation order.

For example, in the image data 51a in FIG. 10, in a case where the body sound data needs to be listened to for at least one second in the site of auscultation position No. 1, the screen creation portion 23 displays the numeral 1 in the right upper portion of the mark of auscultation position No. 1. This allows the measuring person U to know the listening time of the body sound together with the auscultation sites and the auscultation order. This enables avoidance of inconvenience in which the doctor D may not perform a correct diagnosis because a recording time of the body sound data is too short and inconvenience in which hardware resources such as the communication portion and the storage portion are inefficiently consumed because the recoding time of the body sound data is redundantly long.

In addition, the visualization information processing portion 24 may customize the measurement scenario (the auscultation position visualization information) that is decided by the measurement scenario decision portion 22 such that more appropriate measurement is performed in accordance with the condition of the patient P.

For example, in a case where the patient P complains of pain in the region around the right middle lobe, the name of site “right middle lobe” is obtained by the input information obtainment portion 20 as the input information. The visualization information processing portion 24 sets long listening times for No. 4, No. 5, No. 8, No. c, No. f, and No. g among the auscultation positions in the image data 51a based on the name of site “right middle lobe”. Specifically, the visualization information processing portion 24 changes the listening times for the above six sites from one second to five seconds.

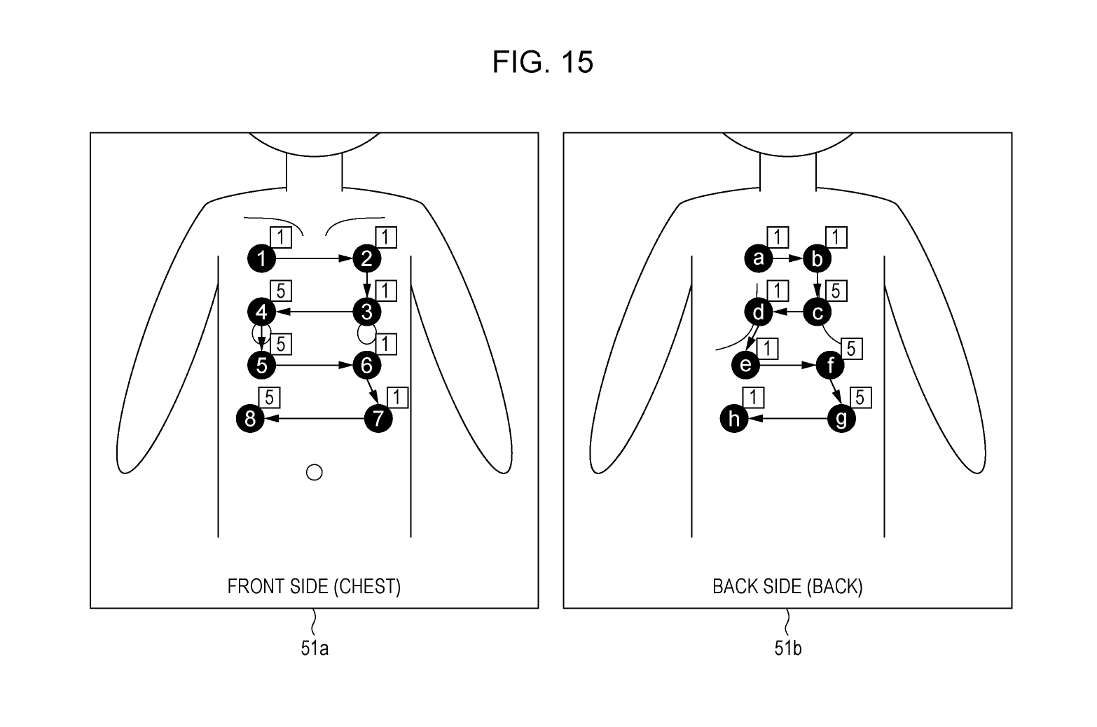

FIG. 15 is a diagram that illustrates other specific examples of the image data 51a and image data 51b that are displayed in the output area 51 on the measurement assistance screen.

The screen creation portion 23 changes the numbers of seconds that are attached to the marks of the auscultation positions of No. 4, No. 5, and No. 8 in the image data 51a and No. c, No. f, and No. g in the image data 51b from 1 to 5 and displays those in the output area 51 as illustrated in FIG. 15.

Alternatively, in a case where the patient P complains of pain in the region around the right upper abdomen, the visualization information processing portion 24 changes the listening time for auscultation position No. 2 in the image data 51d from 3 seconds to 15 seconds. The screen creation portion 23 changes only the number of seconds of auscultation position No. 2 in the image data 51d from 3 to 15 and displays that in the output area 51.

This allows the measuring person U to listen to the body sound data of only the site in which the patient P complains of pain for a longer time than the other sites by following the auscultation position visualization information. As a result, the measuring person U may efficiently perform measurement that is suitable for a present condition of the patient P.

Alternatively, the visualization information processing portion 24 may customize the auscultation position visualization information based on the previous measurement result of the patient P.

For example, it is assumed that the saved information obtainment portion 21 obtains the measurement result of the patient P in the previous measurement from the patient information storage portion 30 (or the measurement result storage portion). It is assumed that a record indicating that an abnormality is found in auscultation position No. 7 in the image data 51a in the previous measurement remains in the measurement result. In this case, the visualization information processing portion 24 changes the number of seconds that is attached to the mark of auscultation position No. 7 in the image data 51a from 1 to 5 and displays that in the output area 51.

A display mode of the listening time in the output area 51 is not particularly limited. The screen creation portion 23 may display the listening time in any way as long as the relationship between the marks of the auscultation positions and the listening times is clear. For example, the screen creation portion 23 may display a numeral of the auscultation time that is surrounded by frames so that the numeral is distinguished from the numerals of the auscultation order (FIG. 15). Further, when the listening is actually started by the measuring person U, the screen creation portion 23 may change the numeral such that the numeral of the listening time in the position is counted down. Further, the screen creation portion 23 may change the display modes of the mark of the auscultation position or the numeral of the listening time at a point where the listening for the necessary number of seconds is completed so that the completion is clearly indicated to the measuring person U. For example, it is possible to make the numeral blink at the point of completion.

In the above-described embodiment, various kinds of devices such as the measurement assistance device 100, the management server 4, and the electronic stethoscope 3 and various kinds of storage portions such as the patient information storage portion 30, the measurement scenario storage portion 31, the measurement result storage portion (storage portion), the table storage portion (storage portion), and the storage portion that stores the auscultation position visualization information that configure the remote measurement system 200 may be realized by cloud computing.

Further, the system or the device that is described herein means an article in which plural devices (or function modules that realize specific functions) are logically gathered, and it does not matter whether or not the devices or the function modules are contained in a single housing. It does not matter either whether or not the storage portions are contained in a single housing.

The present invention is not limited to the above-described embodiment, and various modifications are possible within the scope of the claims. That is, embodiments that are obtained by combining appropriately modified technical means within the scope of the claims are included in the technical scope of the present invention.

[Examples of Realization by Software]

Finally, the blocks of the measurement assistance device 100, particularly, the input information obtainment portion 20, the saved information obtainment portion 21, the measurement scenario decision portion 22, the screen creation portion 23, and the visualization information processing portion 24 may be realized by hardware with logic circuits that are formed on an integrated circuit (IC chip) or may be realized by software by using a central processing unit (CPU).

In the latter case, the measurement assistance device 100 includes the CPU that executes commands of programs that realize the functions, a read only memory (ROM) that stores the programs, a random access memory (RAM) for expanding the programs, storage devices (storage media) such as memories that store the programs and various kinds of data, and so forth. An object of the present invention may be achieved by supplying the recording medium that records program codes (executable programs, intermediate code programs, and source programs) of the control program of the measurement assistance device 100, which is software that implements the above-described functions, in a computer-readable manner to the measurement assistance device 100 and by reading out and executing the program codes recorded in the recording medium by the computer (or the CPU or an MPU).

As the recording medium, a non-transitory tangible medium, for example, tapes such as magnetic tape and cassette tape, disks that include magnetic disks such as Floppy® disk and hard disk and optical disks such as CD-ROM, MO, MD, DVD, and CD-R, cards such as IC card (including memory card) and optical card, semiconductor memories such as mask ROM, EPROM, EEPROM®, and flash ROM, logic circuits such as programmable logic device (PLD) and field programmable gate array (FPGA), or the like may be used.

Further, the measurement assistance device 100 may be configured to be capable of connecting with a communication network and may supply the program codes via the communication network. It is sufficient that the communication network is capable of transmitting the program codes, and the communication network is not particularly limited. For example, the Internet, an intranet, an extranet, a LAN, an ISDN, a VAN, a CATV communication network, a virtual private network, a telephone line network, a mobile communication network, a satellite communication network, and so forth may be used. Further, it is sufficient that transmission medium that configures the communication network is a medium that is capable of transmitting the program codes, and the transmission medium is not limited to ones in particular configurations or of particular kinds. For example, wired communication such as IEEE 1394, a USB, power line communication, a cable TV line, a telephone line, and an asymmetric digital subscriber line (ADSL) and wireless communication such as infrared rays such as IrDA and a remote controller, Bluetooth®, IEEE 802.11 radio, high data rate (HDR), near field communication (NFC), Digital Living Network Alliance (DLNA), a cellular phone network, a satellite line, and a terrestrial digital network may be used. The present invention may be realized by a mode of computer data signals embedded in a carrier in which the program codes are realized by electronic transmission.

### INDUSTRIAL APPLICABILITY

A measurement assistance device of the present invention may be applied to a remote measurement system. A remote measurement system represents a system that is employed under an environment where a measuring person that performs measurement of a measured subject and obtains a measurement result is remote from an executing person who executes some determinations, processes, and so forth by using the measurement result. As an example, the measurement assistance device of the present invention is particularly preferably used in the remote auscultation system in which the measuring person performs measurement (auscultation) of a patient and a doctor in a remote place performs a diagnosis by using an auscultation result.

### REFERENCE SIGNS LIST

1 clinic
2 support center
3 electronic stethoscope (measurement tool)
4 management server
5 communication network
10 control portion
11 input portion
12 display portion
13 storage portion
14 communication portion
20 input information obtainment portion (input information obtainment means)
21 saved information obtainment portion (saved information obtainment means)
22 measurement scenario decision portion (measurement scenario decision means)
23 screen creation portion (information display means)
24 visualization information processing portion (visualization information processing means)
30 patient information storage portion (storage portion)
31 measurement scenario storage portion (storage portion)
100 measurement assistance device
200 remote measurement system

1-11. (canceled)

12. A measurement assistance device that assists measurement that is performed on a measured subject, the measurement assistance device comprising:
input information obtainment means that receives an input by the measured subject or a measuring person and obtains input information about the measured subject;
saved information obtainment means that obtains saved information about the measured subject that is stored in a storage portion based on identification information of the measured subject that is contained in the input information;
measurement scenario decision means that decides a measurement scenario that is applied to the measured subject from plural measurement scenarios that indicate contents of measurement that is conducted by the measuring person and are stored in the storage portion based on the input information and the saved information that are obtained for the measured subject; and
information display means that displays the decided measurement scenario on a display portion,
wherein the measurement scenario contains at least visualization information that illustrates a measurement position of measurement to be conducted for the measured subject.

13. The measurement assistance device according to claim 12,
wherein the measurement scenario indicates at least a content of auscultation that the measuring person conducts by using a stethoscope, the visualization information contains information that specifies an auscultation position, and
the information display means displays visualization information that is image data in which a mark that indicates the auscultation position is added to a virtual human body image on the display portion.

14. The measurement assistance device according to claim 13,
wherein the input information obtainment means obtains a name of site that indicates a site in which a symptom occurs in the measured subject as the input information, and
the measurement scenario decision means selects a measurement scenario that contains visualization information that indicates auscultation of an organ that corresponds to the name of site.

15. The measurement assistance device according to claim 14,
wherein the measurement scenario further includes procedure information that indicates a procedure of the measurement,
the input information obtainment means further obtains a symptom that occurs in the measured subject as the input information,
the saved information obtainment means obtains a past medical history of the measured subject and a measurement date of the measurement that the measured subject receives in a previous time as the saved information, and
the measurement scenario decision means
selects a measurement scenario to which a procedure of auscultation of a site of occurrence of the symptoms in the previous time is added
in a case where elapsed days from a previous measurement date is shorter than prescribed days and the symptom and the name of site of the measured subject correspond to the past medical history of the measured subject.

16. The measurement assistance device according to claim 13,
wherein the visualization information contains information that specifies an auscultation order, and
the information display means displays image data in which symbols that indicate the auscultation orders are added to the marks on the display portion.

17. The measurement assistance device according to claim 16,
wherein the visualization information contains information that specifies a listening time, and
the information display means displays image data in which numerals that indicate the listening times are added to the marks on the display portion.

18. The measurement assistance device according to claim 17, further comprising:
visualization information processing means that customizes the visualization information that is contained in the measurement scenario that is decided by the measurement scenario decision means based on at least one of the input information and the saved information of the measured subject.

19. The measurement assistance device according to claim 18,
wherein the input information obtainment means obtains a name of site that indicates a site in which a symptom occurs in the measured subject as the input information, and
the visualization information processing means sets the listening time of the auscultation position that corresponds to the obtained name of site longer than other auscultation positions.

20. A measurement assistance method that is executed by a measurement assistance device that assists measurement that is performed on a measured subject, the measurement assistance method comprising:
an input information obtainment step of receiving an input by the measured subject or a measuring person and obtaining input information about the measured subject;
a saved information obtainment step of obtaining saved information about the measured subject that is stored in a storage portion based on identification information of the measured subject that is contained in the input information;
a measurement scenario decision step of deciding a measurement scenario that is applied to the measured subject from plural measurement scenarios that indicate contents of measurement that is conducted by the measuring person and are stored in the storage portion based on the input information and the saved information that are obtained for the measured subject; and
an information display step of displaying the decided measurement scenario on a display portion of the measurement assistance device,
wherein the measurement scenario contains at least visualization information that illustrates a measurement position of measurement to be conducted for the measured subject.

21. A non-transitory computer readable medium that is readable by a computer and records the control program that causes a computer to function as the means of the measurement assistance device according to claim 12.

22. The measurement assistance device according to claim 14,
wherein the visualization information contains information that specifies an auscultation order, and
the information display means displays image data in which symbols that indicate the auscultation orders are added to the marks on the display portion.

23. The measurement assistance device according to claim 22,
wherein the visualization information contains information that specifies a listening time, and
the information display means displays image data in which numerals that indicate the listening times are added to the marks on the display portion.

24. The measurement assistance device according to claim 23, further comprising:
visualization information processing means that customizes the visualization information that is contained in the measurement scenario that is decided by the measurement scenario decision means based on at least one of the input information and the saved information of the measured subject.

25. The measurement assistance device according to claim 24,
wherein the input information obtainment means obtains a name of site that indicates a site in which a symptom occurs in the measured subject as the input information, and
the visualization information processing means sets the listening time of the auscultation position that corresponds to the obtained name of site longer than other auscultation positions.

26. The measurement assistance device according to claim 15,
wherein the visualization information contains information that specifies an auscultation order, and
the information display means displays image data in which symbols that indicate the auscultation orders are added to the marks on the display portion.

27. The measurement assistance device according to claim 26,
wherein the visualization information contains information that specifies a listening time, and
the information display means displays image data in which numerals that indicate the listening times are added to the marks on the display portion.

28. The measurement assistance device according to claim 27, further comprising:
visualization information processing means that customizes the visualization information that is contained in the measurement scenario that is decided by the measurement scenario decision means based on at least one of the input information and the saved information of the measured subject.

29. The measurement assistance device according to claim 28,
wherein the input information obtainment means obtains a name of site that indicates a site in which a symptom occurs in the measured subject as the input information, and
the visualization information processing means sets the listening time of the auscultation position that corresponds to the obtained name of site longer than other auscultation positions.
